(19) United States
(12) Patent Application Publication
(10) Pub. No.: US 2023/0356746 A1
(43) Pub. Date: Nov. 9, 2023

(54) PRESENTATION CONTROL DEVICE AND NON-TRANSITORY COMPUTER READABLE MEDIUM

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 18/355,028

(22) Filed: Jul. 19, 2023

Related U.S. Application Data
(63) Continuation of application No. PCT/JP2021/047485, filed on Dec. 22, 2021.

(30) Foreign Application Priority Data
Jan. 21, 2021 (JP) 2021-008131
Oct. 6, 2021 (JP) 2021-164999

(51) Int. Cl. B60W 60/00; B60W 50/14; B60W 40/04

(52) U.S. Cl. CPC B60W 60/001; B60W 50/14; B60W 40/04

(57) ABSTRACT

A presentation control device is for a vehicle having an automated driving function capable of performing automated driving without driver's obligation to monitor surroundings. The presentation control device controls presentation of information related to the automated driving. The presentation control device includes a state grasping unit and a state notification unit. The state grasping unit grasps an execution pattern state selected from among execution patterns in the automated driving function. The execution patterns are included in the automated driving without the driver's obligation to monitor the surroundings. The state notification unit notifies a change of the execution pattern state when the execution pattern state changes while the automated driving without the driver's obligation to monitor the surroundings is continued. The state notification unit notifies a schedule of the change of the execution pattern state in advance before notifying the change of the execution pattern state.

### CROSS REFERENCE TO RELATED APPLICATIONS

The present application is a continuation application of International Patent Application No. PCT/JP2021/047485 filed on Dec. 22, 2021, which designated the U.S. and claims the benefit of priority from Japanese Patent Application No. 2021-008131 filed on Jan. 21, 2021 and Japanese Patent Application No. 2021-164999 filed on Oct. 6, 2021. The entire disclosures of all of the above applications are incorporated herein by reference.

### TECHNICAL FIELD

The present disclosure relates to a presentation control device and non-transitory computer readable medium for presenting information related to automated driving.

### BACKGROUND

In an automated driving system, a driver is permitted to perform a second task such as operation of a smartphone and viewing of a television during automated driving.

### SUMMARY

According to at least one embodiment, in presentation control techniques being configured to control presentation of information related to automated driving without driver's obligation to monitor surroundings, being configured to grasp an execution pattern state selected from among execution patterns in the automated driving function, the execution patterns being included in the automated driving without the driver's obligation to monitor the surroundings, notify a change of the execution pattern state when the execution pattern state changes while the automated driving without the driver's obligation to monitor the surroundings is continued, and notify a schedule of the change of the execution pattern state in advance before notifying the change of the execution pattern state.

### BRIEF DESCRIPTION OF THE DRAWINGS

The details of one or more embodiments are set forth in the accompanying drawings and the description below. Other features and advantages will be apparent from the description and drawings, and from the claims.

FIG. 1 is a diagram showing a whole image of an in-vehicle network including a human machine interface control unit (i.e., HCU) according to a first embodiment of the present disclosure.

FIG. 2 is a diagram showing an example of a layout of interfaces around a driver's seat.

FIG. 3 is a flowchart showing details of a possibility determination process of determining whether automated driving at a congestion level 3 is possible.

FIG. 4 is a flowchart showing details of a possibility determination process of determining whether automated driving at an area level 3 is possible.

FIG. 5 is a flowchart showing details of a control switching process for switching an execution pattern of eyes-off automated driving.

FIG. 6 is a time chart showing details of control in a scene in which a vehicle enters a permission area while automated driving at a congestion level 3 is maintained.

FIG. 7 is a time chart showing details of control in a scene in which a vehicle travels in a traffic congestion section in a permission area.

FIG. 8 is a time chart showing details of control in a scene in which a vehicle exits a permission area while automated driving at a congestion level 3 is maintained.

FIG. 9 is a flowchart showing details of a notification control process for controlling a change notification and a periphery monitoring notification.

FIG. 10 is a time chart showing details of control in a scene in which a vehicle enters a permission area while automated driving at a congestion level 3 is maintained in to second embodiment of the present disclosure.

FIG. 11 is a diagram showing a whole image of an in-vehicle network including a HCU according to a third embodiment of the present disclosure.

FIG. 12 is a time chart showing details of control in a scene in which a vehicle enters a restricted permission area from a non-permission area in traffic congestion.

FIG. 13 is a flowchart showing details of a notification control process for controlling a level 3 impossibility notification and an advance notification.

### DETAILED DESCRIPTION

To begin with, examples of relevant techniques will be described.

In an automated driving system according to a comparative example, a driver is permitted to perform a second task such as operation of a smartphone and viewing of a television during automated driving. The automated driving system determines that the automated driving cannot be continued, and issues warning to the driver when reliability of the automated driving system decreases.

In the comparative example, the automated driving in which the driver is permitted to perform the second task is the automated driving in which the driver is not obliged to monitor surroundings. In recent years, it has been studied to set execution patterns as automated driving in which a driver is not obliged to monitor surroundings. As described above, in a case where execution patterns are set for the automated driving without surroundings monitoring obligation, a scene in which a state of an execution pattern may change while the automated driving by the automated driving system is continued. In such a scene, the driver cannot perceive a current state of an execution pattern, and thus there is a concern that convenience of the automated driving may be impaired.

In contrast to the comparative example, according to a presentation control device and non-transitory computer readable medium, convenience for automated driving can be ensured.

According to one aspect of the present disclosure, presentation control techniques is for a vehicle having an automated driving function capable of performing automated driving without driver's obligation to monitor surroundings. The presentation control techniques control presentation of information related to the automated driving. The presentation control techniques grasp an execution pattern state selected from among execution patterns in the automated driving function. The execution patterns are included in the automated driving without the driver's obligation to monitor the surroundings. The presentation control techniques notify a change of the execution pattern state when the execution pattern state changes while the automated driving without the driver's obligation to monitor the surroundings is continued. The presentation techniques notify a schedule of the change of the execution pattern state in advance before notifying the change of the execution pattern state.

According to this configuration, even when execution patterns are included in the automated driving in which the driver is not obliged to monitor the surroundings, an occupant such as the driver can perceive the current state of the execution pattern by an automated driving function. According to the above, since the driver can easily grasp what kind of automated driving is performed, convenience of automated driving can be ensured.

According to one aspect of the present disclosure, presentation control techniques are for a vehicle having an automated driving function capable of performing automated driving without driver's obligation to monitor surroundings. The presentation control techniques control presentation of information related to the automated driving. The presentation control device techniques grasp an execution pattern state selected from among execution patterns in the automated driving function. The execution patterns include area-limited control executed only for a specific area and congestion-limited control executed only for traveling in a traffic congestion section. The presentation control techniques notify to prompt the driver to monitor the surroundings when the execution pattern state of the automated driving is switched from one of the area-limited control and the congestion-limited control to the other.

According to these aspects, in a case where the execution pattern of the automated driving changes between the area-limited control performed only in the specific area and the congestion-limited control performed only in the traveling in the congestion, the occupant such as the driver is prompted to perform the periphery monitoring. If the notification prompting the surrounding monitoring is performed without the surrounding monitoring obligation, the occupant can easily perceive the current state of the execution pattern. As a result, the occupant can flexibly respond to the change in the vehicle behavior caused by the state change of the execution pattern. Therefore, the convenience of automated driving can be ensured.

According to one aspect of the present disclosure, presentation control techniques control presentation of information related to automated driving without driver's obligation to monitor surroundings. The presentation control techniques grasp a switching schedule of execution patterns to be implemented. The execution patterns are included in the automated driving without the driver's obligation to monitor the surroundings. The presentation control techniques grasp a movement schedule from a non-permission area in which traveling by the automated driving without the driver's obligation to monitor the surroundings is not permitted to a permission area in which traveling by the automated driving without the driver's obligation to monitor the surroundings is permitted. The presentation control techniques perform a switching advance notification that indicates to the driver that the switching schedule of the execution patterns has been grasped during traveling by the automated driving without the obligation to monitor the surroundings. The presentation control techniques control that an output mode of an area advance notification is different from an output mode of the switching advance notification when the vehicle is traveling in the non-permission area in a traffic congestion state. The area advance notification indicates to the driver that the movement schedule to the permission area is recognized.

In these modes, since the mode of the area advance notification indicating to the driver that the vehicle is scheduled to move to the permission area is different from the mode of the switching advance notification indicating to the driver that the automated driving execution pattern is scheduled to be switched, the area advance notification can be distinguished from the switching advance notification. Therefore, it is possible to avoid a situation in which the area advance notification performed while the vehicle is traveling in the non-permission area in the traffic congestion section is mistakenly interpreted as enabling the automatic driving without the surroundings monitoring obligation. As described above, it is easy to grasp the state of the automated driving, and thus it is possible to ensure convenience of the automated driving.

According to one aspect of the present disclosure, presentation control techniques control presentation of information related to automated driving without driver's obligation to monitor surroundings. The presentation control techniques grasp a movement schedule from a non-permission area in which traveling by the automated driving without the driver's obligation to monitor the surroundings is not permitted to a permission area in which traveling by the automated driving without the driver's obligation to monitor the surroundings is permitted. The presentation control techniques perform a non-permission area notification when the movement schedule to the permitted area is grasped while traveling in the non-permitted area and the surroundings of the vehicle are in a traffic congestion state. The non-permission area notification indicates that the vehicle is in the traffic congestion state and indicates that traveling by the automated driving without the driver's obligation to monitor the surroundings is not permitted.

In these aspects, in a case where a movement schedule to the permission area is grasped while traveling in the prohibited area in the congestion state, it is clearly indicated to the driver by the prohibited area notification that traveling by the automatic driving without the surroundings monitoring obligation is not permitted. Therefore, it is possible to avoid a situation in which it is erroneously recognized that traveling by automatic driving without the surroundings monitoring obligation is possible due to the congestion state even before entering the permission area. As described above, it is easy to grasp the state of the automated driving, and thus it is possible to ensure convenience of the automated driving.

Hereinafter, a plurality of embodiments of the present disclosure will be described with reference to the drawings. In the following respective embodiments, corresponding structural elements are indicated by the same reference signs and may not be redundantly described in some cases. When only a part of the configuration is described in each embodiment, the configuration of the other embodiments described above can be applied to other parts of the configuration. Besides the explicitly described combination(s) of structural components in each of the following embodiments, the structural components of different embodiments may be partially combined even though such a combination(s) is not explicitly explained as long as there is no problem. Unspecified combinations of the configurations described in the plurality of embodiments and the modification examples are also disclosed in the following description.

### First Embodiment

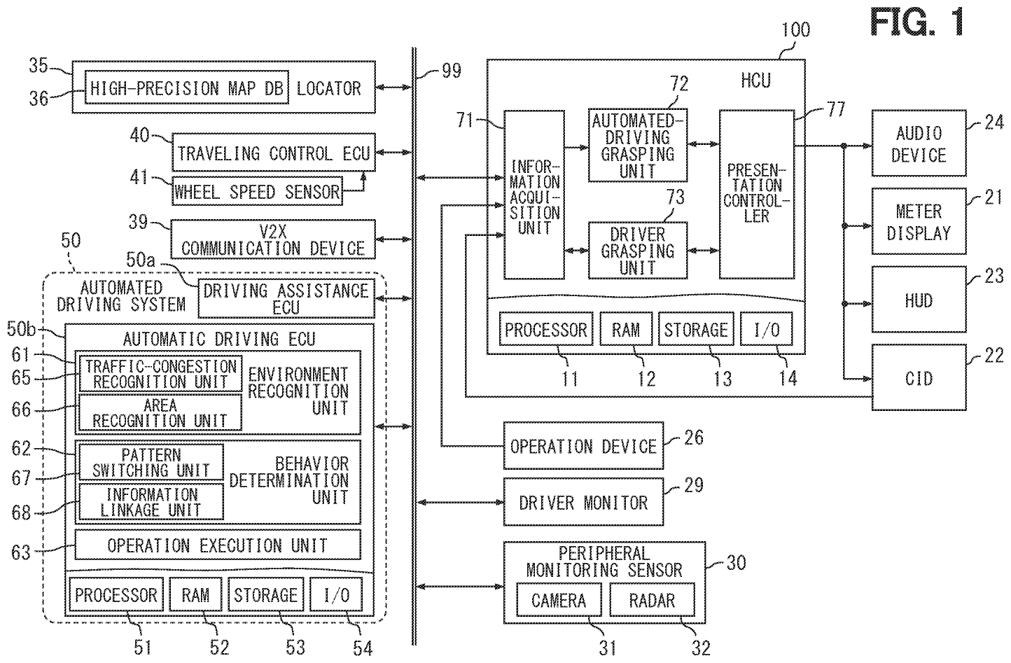

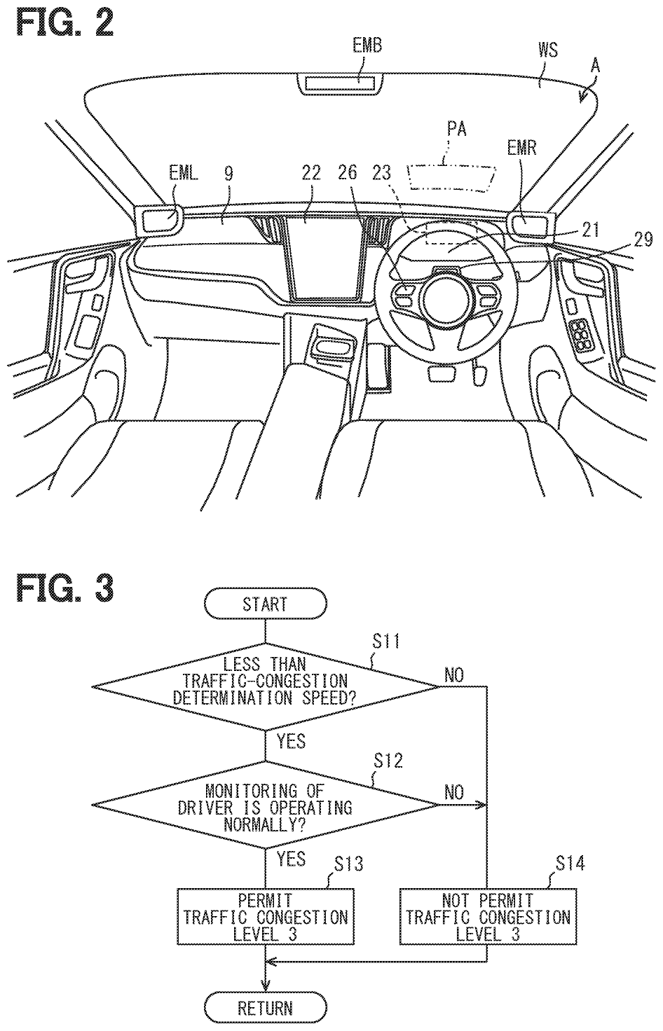

Functions of a presentation control device according to a first embodiment of the present disclosure is provided by a human machine interface control unit (i.e., HCU) 100 shown in FIG. 1. As shown in FIGS. 1 and 2, a human machine Interface (i.e., HMI) system used in a vehicle A includes the HCU 100, display devices, an audio device 24, and an operation device 26. The HMI system has an input interface function that accepts an operation made by an occupant (for example, a driver) of the vehicle A, and an output interface function that presents information to the driver.

The HCU 100 is communicably connected to a communication bus 99 of an in-vehicle network mounted on the vehicle A. The HCU 100 is one of nodes connected to the in-vehicle network. A driver monitor 29, a peripheral monitoring sensor 30, a locator 35, a vehicle to everything (i.e., V2X) communication device 39, a travel control electronic control unit (i.e., ECU) 40, a driving assistance ECU 50a, an automatic driving ECU 50b, and the like are connected to the communication bus 99. These nodes connected to the communication bus 99 of the in-vehicle network can communicate with each other. It should be noted that specific nodes among the multiple devices and the multiple ECUs may be directly electrically connected with one another and can communicate with one other without using the communication bus 99.

The driver monitor 29 includes a near-infrared light source, a near-infrared camera, and a controller that controls them. The driver monitor 29 is installed, for example, on an upper surface of a steering column portion or an upper surface of an instrument panel 9 in a posture in which the near-infrared camera faces a headrest portion of a driver's seat. The near-infrared camera may be integrated with a meter display 21 or a center information display (i.e., CID) 22 to be described later so as to be placed in either screen.

The driver monitor 29 photographs, with the near-infrared camera, a head of a driver that is irradiated with near-infrared light by the near-infrared light source. An image captured by the near-infrared camera is subjected to image analysis by the controller. The controller extracts information such as an eye point position of the driver and a line-of-sight direction based on the captured image. The driver monitor 29 provides driver status information extracted by the controller to the HCU 100 and the automated driving ECU 50b via the communication bus 99.

The peripheral monitoring sensor 30 is an autonomous sensor that monitors a periphery environment of the vehicle A. The peripheral monitoring sensor 30 is capable of detecting a moving object and a stationary object specified in advance from a detection range around the vehicle A. The peripheral monitoring sensor 30 is capable of detecting at least a front vehicle, a rear vehicle, a left vehicle and a right vehicle traveling around the vehicle A. The peripheral monitoring sensor 30 provides detection information of objects around the vehicle to the driving assistance ECU 50a, the automated driving ECU 50b, and the like.

The peripheral monitoring sensor 33 includes, for example, a camera unit 31 and a millimeter wave radar 32. The camera unit 31 may have a monocular camera or may have a compound-eye camera. The camera unit 31 is mounted on the vehicle A so as to be able to image a range in front of the vehicle A. The camera unit 31 capable of imaging side ranges and a rear range of the vehicle A may be mounted on the vehicle A. The camera unit 31 outputs at least one of imaging data obtained by imaging surroundings of the vehicle and an analysis result of the imaging data as detection information. The millimeter wave radar 32 emits a millimeter wave or a quasi-millimeter wave toward periphery of the vehicle. The millimeter wave radar 32 outputs detection information generated by processing to receive a reflected wave reflected by a moving object, a stationary object, or the like. The peripheral monitoring sensor 30 may further include a detection configuration such as a rider and a sonar.

The locator 35 includes a global navigation satellite systems (i.e., GNSS) receiver, an inertial sensor, and the like. The locator 35 combines positioning signal received by the GNSS receiver, measurement result of the inertial sensor, traveling speed information output to the communication bus 99, and the like, and successively specifies a position and a travelling direction of the vehicle A. The locator 35 sequentially outputs location information and direction information about the vehicle A based on the specified result to the communication bus 99 as locator information.

The locator 35 further has a high-precision map database (hereinafter referred to as high-precision map DB) 36. The high-precision map DB 36 mainly includes a large-capacity storage medium storing a large number of pieces of three-dimensional map data and two-dimensional map data. The three-dimensional map data is so-called HD (High Definition) map data, and includes road information necessary for automated driving control. The three-dimensional map data includes information necessary for advanced driving assistance and automated driving, such as three-dimensional shape information on a road and detailed information on each lane. The locator 35 reads map data around a current position from the high-precision map DB 36, and provides it to the driving assistance ECU 50a, the automatic driving ECU 50b, and the like with locator information.

The V2X communication device 39 is a vehicle exterior communication unit mounted on the vehicle A. The V2X communication device 39 transmits and receives information to and from a roadside device installed on a side of the road by wireless communication. In one example, the V2X communication device 39 receives traffic congestion information around the current position of the vehicle A and in a traveling direction from a roadside device. The traffic congestion information is VICS (registered trademark) information or the like. The V2X communication device 39 provides the received traffic congestion information to the automated driving ECU 50b and the HCU 100.

The traveling control ECU 40 is an electronic control device that mainly includes a microcontroller. The travel control ECU 40 has at least functions of a brake control ECU, a drive control ECU, and a steering control ECU. The travel control ECU 40 continuously executes a braking force control of each wheel, an output control of an in-vehicle power source, and a steering angle control based on any one of an operation command based on a driving operation by the driver, a control command by the driving assistance ECU 50a, and a control command by the automated driving ECU 50b. In addition, the travel control ECU 40 generates traveling speed information indicating current traveling speed of the vehicle A based on a detection signal of a wheel speed sensor 41 provided in a hub portion of each wheel, and the sequentially outputs the generated traveling speed information to the communication bus 99.

The driving assistance ECU 50a and the automated driving ECU 50b are mounted on the vehicle A as in-vehicle ECUs including the automated driving system 50. By mounting the automated driving system 50, the vehicle A becomes an automated driving vehicle provided with an automated driving function.

The driving assistance ECU 50a is an in-vehicle ECU that implements a driving assistance function that assists driving operation of the driver in the automated driving system 50. The driving assistance ECU 50a enables advanced driving assistance of about Level 2 or partial automated travel control at an automated driving level defined by the Society of Automotive Engineers. The automated driving performed by the driving assistance ECU 50a is automated driving in which the driver is obliged to monitor surroundings of the vehicle.

The driving assistance ECU 50a is a computer mainly including a control circuit including a processing unit, a random access memory (i.e., RAM), a storage unit, an I/O interface, a bus connecting them, and the like. The driving assistance ECU 50a includes functional units that realize advanced driving assistance by the processing unit executing a program. Specifically, the driving assistance ECU 50a includes an adaptive cruise control (i.e., ACC) functional unit, a lane tracking assist (i.e., LTA) functional unit, and a lane change assist (i.e., LCA) functional unit.

The automated driving ECU 50b is an in-vehicle ECU that implements an automatic driving function capable of acting for the driving operation of the driver in the automated driving system 50. The automated driving ECU 50b is capable of performing autonomous traveling of a level 3 or higher in which the automated driving system 50 is a control subject. The automated driving ECU 50b enables eyes-off automated driving that does not require the driver to visually monitor the surroundings of the vehicle. The automated driving ECU 50b may be capable of implementing an automated driving function of Level 4 or higher.

In the automated driving system 50, traveling control state of the automated driving function is switched among multiple functions including at least an automated driving control with the obligation to monitor the surroundings by the driving assistance ECU 50a and the automated driving control without the obligation to monitor the surroundings by the automated driving ECU 50b. In the following description, the automated driving control of the level 2 or lower by the driving assistance ECU 50a may be described as “driving assistance control”, and the automated driving control of the level 3 or higher by the automated driving ECU 50b may be described as “autonomous traveling control”.

The automated driving ECU 50b is a computer mainly including a control circuit including a processing unit 51, a RAM 52, a storage 53, an I/O interface 54, a bus connecting them, and the like. The automated driving ECU 50b has higher calculation capability than the driving assistance ECU 50a, and can execute at least travel control corresponding to ACC, LTA, and LCA. In a scene where the autonomous traveling control is temporarily interrupted, the automated driving ECU 50b may perform the driving assistance control in which the driver is obligated to monitor the surroundings instead of the driving assistance ECU 50a. The automated driving ECU 50b includes an environment recognition unit 61, a behavior determination unit 62, and an operation execution unit 63 as function units that implement an eyes-off automated driving (the autonomous traveling control) by execution of a program by the processing unit 51.

The environment recognition unit 61 recognizes traveling environment of the vehicle A based on the locator information and map data acquired from the locator 35 and the detection information acquired from the peripheral monitoring sensor 30. More specifically, the environment recognition unit 61 grasps a position of a driver's vehicle lane on which the driver's vehicle travels among lanes, a lane shape of the driver's vehicle lane, and a relative position, relative speed, and others of another vehicle around the driver's vehicle. Note that the position of the driver's vehicle lane may be identified by the locator 35.

The environment recognition unit 61 includes a traffic-congestion recognition unit 65 and an area recognition unit 66 as sub-functional units. The traffic-congestion recognition unit 65 recognizes traffic congestion around the vehicle. The traffic-congestion recognition unit 65 determines that the vehicle A is traveling in the traffic congestion when the traveling speed of the vehicle A is equal to or less than a predetermined speed (hereinafter, a traffic-congestion determination speed) set in advance based on the traveling speed information acquired from the communication bus 99 (see step S11 in FIG. 3). The traffic-congestion determination speed is set to, for example, about 10 km/h. The traffic-congestion recognition unit 65 may perform the congestion determination based on, for example, a determination result of whether there is a preceding vehicle and a side vehicle, or detection information such as congestion information received by the V2X communication device 39.

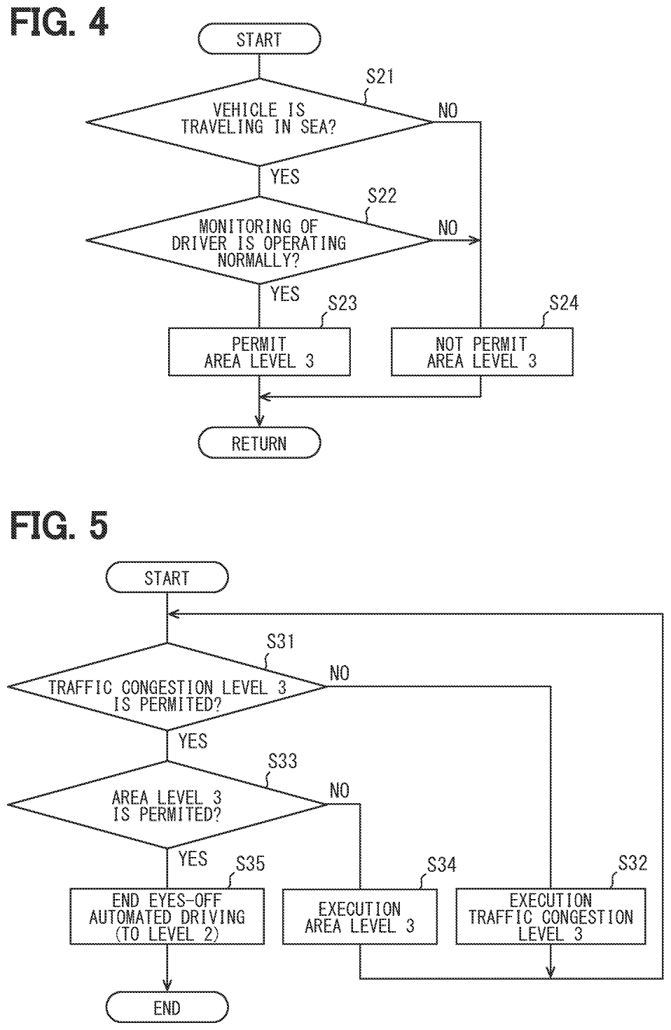

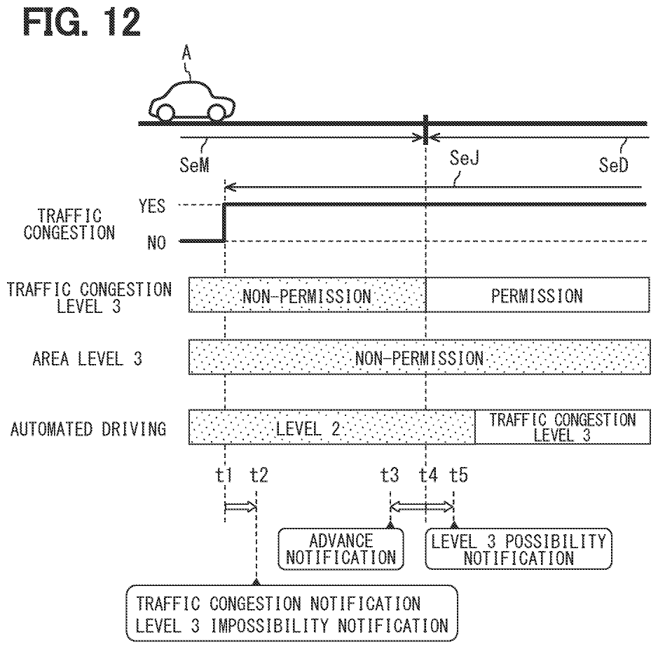

The area recognition unit 66 determines whether a road on which the vehicle is traveling or a road on which the vehicle is scheduled to travel is in a permission area SeA set in advance (see step S21 in FIG. 4). Further, the area recognition unit 66 determines whether the road on which the vehicle travels or the road on which the vehicle is scheduled to travel is in a restricted permission area SeD set in advance. The permission area SeA and the restricted permission area SeD may be limited areas (Operational Design Domain, ODD) in which the eyes-off automated driving without driver's obligation to monitor the surroundings is legally permitted. As an example, the permission area SeA and the restricted permission area SeD are set on a main road such as an expressway including a motorway. On the other hand, for example, on a road such as a general road that is not included in either the permission area SeA or the restricted permission area SeD (hereinafter, a non-permission area SeM, see FIG. 12), traveling by the eyes-off automated driving without the surroundings monitoring obligation is not permitted.

Information on whether an area is the permission area SeA and the restricted permission area SeD may be recorded in the map data stored in the high-precision map DB 36 or may be included in reception information received by the V2X communication device 39. The area recognition unit 66 appropriately combines current position information, the map data, the reception information, and the like, and determines whether the area is the permission area SeA or the restricted permission area SeD. The determination of whether the area is the permission area SeA or the restricted permission area SeD may be performed by the locator 35 instead of the area recognition unit 66. In such a mode using the locator 35, the area recognition unit 66 acquires an area recognition result for a road on which the vehicle is traveling and a road on which the vehicle is scheduled to travel from the locator 35.

The behavior determination unit 62 cooperates with the HCU 100 to control driving switching between the automated driving system 50 and the driver. The behavior determination unit 62 generates a traveling plan to travel the vehicle A based on the recognition result of the traveling environment by the environment recognition unit 61 when the automated driving system 50 has a right to control the driving operation.

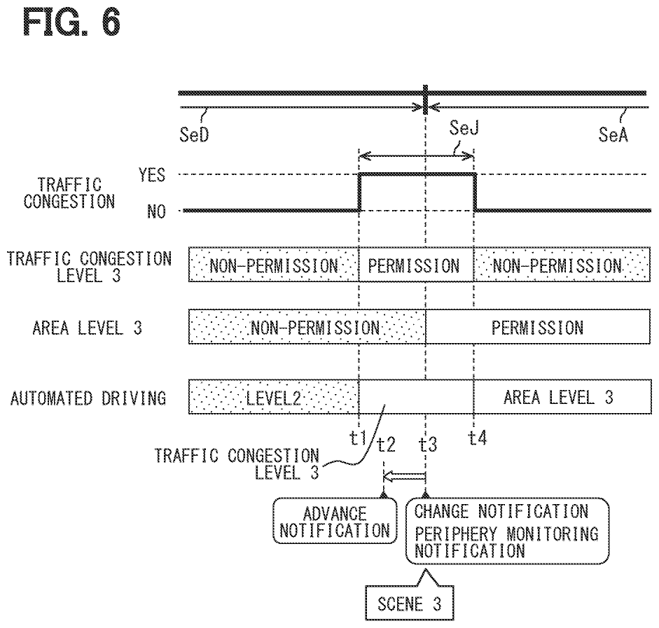

The behavior determination unit 62 includes a pattern switching unit 67 and an information linkage unit 68 as sub-functional units. The pattern switching unit 67 switches the execution pattern of the eyes-off automated driving among execution patterns. The execution patterns include a traffic-congestion limited control (hereinafter, a traffic congestion level 3) that is implemented only during traveling in traffic congestion, and an area limited control (hereinafter, an area level 3) that is implemented only in the permission area SeA (see FIG. 6). In the automated driving control of the traffic congestion level 3, the behavior determination unit 62 generates a traveling plan to follow the preceding vehicle while securing a distance from the preceding vehicle. In the automated driving control of the area level 3, the behavior determination unit 62 generates a traveling plan to follow the preceding vehicle or to cruise at a constant speed along the driver's vehicle lane. As an example, traveling at an inter-vehicle distance in the automated driving control of the traffic congestion level 3 narrower than that in the automated driving control of the area level 3 is permitted. On the other hand, traveling at a higher speed (the maximum speed is, for example, 60 km/h) in the automated driving control of the area level 3 than in the automated driving control of the traffic congestion level 3 is permitted.

The pattern switching unit 67 performs a possibility determination process (see FIG. 3) of determining whether automated driving of the traffic congestion level 3, a possibility determination process (see FIG. 4) of determining whether automated driving of the area level 3, and a control switching process (see FIG. 5) of switching the execution pattern of automated driving. Each possibility determination process is started based on an instruction to start the eyes-off automated driving based on a driver operation, and is repeatedly performed until an end of the eyes-off automated driving. Each possibility determination process may be interrupted while the vehicle is traveling in the non-permission area SeM.

In the possibility determination process of the traffic congestion level 3 (see FIG. 3), the pattern switching unit 67 refers to a result of congestion recognition by the traffic-congestion recognition unit 65 and determines whether the traveling speed of the vehicle is equal to or less than the traffic-congestion determination speed (see step S11). Further, the pattern switching unit 67 determines whether the monitoring of the driver by the driver monitor 29 is operating normally based on the driver status information received by the information linkage unit 68 (see step S12). The pattern switching unit 67 permits an execution of the automated driving of the traffic congestion level 3 when the traveling speed of the vehicle is equal to or less than the traffic-congestion determination speed and the monitoring of the driver by the driver monitor 29 is normally operating (see step S13). On the other hand, the pattern switching unit 67 does not permit the execution of the automated driving of the traffic congestion level 3 when the traveling speed of the vehicle exceeds the traffic-congestion determination speed, or when the driver monitoring is not operating normally (see step S14).

In the possibility determination process of the area level 3 (see FIG. 4), the pattern switching unit 67 refers to the recognition result of the permission area SeA by the area recognition unit 66, and determines whether the vehicle is traveling in the permission area SeA (see step S21). The pattern switching unit 67 may further determine a plan for the vehicle to enter the permission area SeA and a plan for the vehicle to exit the permission area SeA. The pattern switching unit 67 determines whether the monitoring of the driver is operating normally based on the driver status information received by the information linkage unit 68 (see step S22). The pattern switching unit 67 permits the execution of the automated driving of the area level 3 when the vehicle is traveling in the permission area SeA and the driver monitoring by the driver monitor 29 is normally operating (see step S23). On the other hand, the pattern switching unit 67 does not permit the execution of the automated driving of the area level 3 when the vehicle is traveling outside the permission area SeA or when the driver monitoring is not operating normally (see step S24).

In the control switching process of the execution pattern (see FIG. 5), the pattern switching unit 67 determines whether the traffic congestion level 3 is in permission state based on the determination result in the possibility determination process of the traffic congestion level 3 (see step S31). The pattern switching unit 67 sets the traffic congestion level 3 as the execution pattern of the eyes-off automated driving when the traffic congestion level 3 is in the permission state (see step S32). On the other hand, the pattern switching unit 67 determines whether the area level 3 is in the permission state based on the determination result in the possibility determination process of the area level 3 when the area level 3 is not in the permission state (see step S33). The pattern switching unit 67 sets the area level 3 to the execution pattern of the eyes-off automated driving when the area level 3 is in the permission state (see step S34). On the other hand, the eyes-off automated driving is ended when both the traffic congestion level 3 and the area level 3 are not permitted (see step S35). In this case, the automated driving system 50 executes the automated driving in which the driver is obliged to monitor the surroundings.

The information linkage unit 68 performs information linkage with the automated driving ECU 50b, the driver monitor 29, and the like. The information linkage unit 68 provides control status information indicating execution state of the automated driving in the automated driving system 50 to the HCU 100. More specifically, the information linkage unit 68 outputs, to the HCU 100, information such as whether the eyes-off automated driving is to be continued, a schedule of a state change of the execution pattern, and execution property states of the traffic congestion level 3 and the area level 3.

The information linkage unit 68 receives the driver status information detected by the driver monitor 29. The driver status information includes operation information indicating whether the driver monitoring is operating normally, and action information indicating whether the driver is appropriately monitoring the surroundings. The action information does not affect the switching of the execution pattern of the eyes-off automated driving by the pattern switching unit 67. That is, even when the information linkage unit 68 recognizes that the driver does not monitor the periphery, the pattern switching unit 67 permits the switching of the execution pattern. The HCU 100 (a driver grasping unit 73 described later) may generate the action information based on information detected by the driver monitor 29. In such a mode, the information linkage unit 68 is capable of linking information with the HCU 100.

The operation execution unit 63 performs acceleration-deceleration control and steering control of the vehicle A according to the traveling plan generated by the behavior determination unit 62 in cooperation with the traveling control ECU 40 when the automated driving system 50 has the right to control the driving operation. More specifically, the operation execution unit 63 generates control commands based on the traveling plan, and sequentially outputs the generated control commands to the traveling control ECU 40.

Next, the details of each of a plurality of display devices, the audio device 24, the operation device 26, and the HCU 100 included in the HMI system will be described in order.

The display devices include a meter display 21, a CID 22, a head-up display (hereinafter referred to as HUD) 23, and the like. The display devices may further include each display EMB, EML, EMR (see FIG. 2) of an electronic mirror system.

The meter display 21, the CID 22, and the HUD 23 present information through driver's visual perception. The meter display 21 and the CID 22 mainly include, for example, a liquid crystal display or an OLED (Organic Light Emitting Diode) display. The CID 22 has a touch panel function and detects a touch operation on a display screen by the driver or the like. The HUD 23 outputs a virtual image overlapping with a foreground of the vehicle A to the driver by projecting light of an image formed in front of the driver onto a projection area PA defined in a windshield WS or the like.

The audio device 24 presents information through driver's auditory perception. The audio device 24 includes speakers installed in a vehicle compartment in an arrangement surrounding the driver's seat, and outputs a notification sound, a voice message, or the like from the speakers in the vehicle compartment.

The operation device 26 is an input unit that receives an operation of user, such as the driver or the like. The operation of the user or the like related, for example, to an operation and stop of the automated driving function is input to the operation device 26. The operation device 26 includes a steering switch provided on a spoke portion of a steering wheel, an operation lever provided on a steering column portion, a voice input device that recognizes utterance content of the driver, and the like.

The HCU 100 is an in-vehicle computer that controls the meter display 21, the CID 22, the HUD 23, and the audio device 24 in the HMI system. The HCU 100 functions as a presentation control device that comprehensively controls the presentation of information, for example, related to the automated driving to the driver. The HCU 100 mainly includes a control circuit including a processor 11, a RAM 12, a storage 13, an I/O interface 14, a bus that connects them, and the like.

The processor 11 is a hardware combined with the RAM 12, and executes arithmetic processing. The processor 11 includes at least one arithmetic core, such as a central processing unit (i.e., CPU) or a graphics processing unit (i.e., GPU). The processor 11 may further include a field-programmable gate array (i.e., FPGA), a neural network processing unit (i.e., NPU), an IP core having other dedicated functions, and the like. The RAM 12 may include a video RAM for generating video data. The processor 11 executes various processing for implementing a presentation control method of the present disclosure by accessing the RAM 12. The storage 13 includes a non-volatile storage medium. The storage 13 stores various programs, for example, a presentation control program to be executed by the processor 11.

The HCU 100 includes functional units that execute the presentation control program stored in the storage 13 by the processor 11 to integrally control presentation of information to the driver that uses each display device and the audio device 24. More specifically, the HCU 100 includes functional units such as an information acquisition unit 71, an automated-driving grasping unit 72, a driver grasping unit 73, and a presentation controller 77.

The information acquisition unit 71 acquires, from the communication bus 99, vehicle information indicating a state of the vehicle A. The vehicle information includes, for example, the traveling speed information, and control status information indicating the state of the automated driving function. The information acquisition unit 71 acquires operation information indicating a content of the operation of the user from the CID 22, the operation device 26, or the like. The information acquisition unit 71 acquires the driver status information indicating the state of the driver from the driver monitor 29.

The automated-driving grasping unit 72 grasps an implementation state of the automated driving by the automated driving system 50 based on the control status information acquired by the information acquisition unit 71. The automated-driving grasping unit 72 grasps the execution patterns included in the eyes-off automated driving, that is, a pattern currently implemented among the traffic congestion level 3 and the area level 3. The automated-driving grasping unit 72 may be able to further grasp not only the current execution pattern but also an implementation schedule up to a predetermined time ahead. More specifically, the automated-driving grasping unit 72 grasps a change in the execution pattern from the traffic congestion level 3 to the area level 3, a change in the execution pattern from the area level 3 to the traffic congestion level 3, and the like. Further, the automated-driving grasping unit 72 grasps entry and exit to and from the permission area SeA in the automated driving of the traffic congestion level 3.

The driver grasping unit 73 grasps whether the driver has performed the periphery monitoring based on the driver status information acquired by the information acquisition unit 71. More specifically, the driver grasping unit 73 grasps whether the driver has performed the periphery monitoring in a case where an end of the eyes-off automated driving is scheduled and in a case where a periphery monitoring notification (described later) based on a switching schedule of the execution pattern of the eyes-off automated driving is performed.

The presentation controller 77 integrally controls presentation of information to the driver that uses each display device and the audio device 24. The presentation controller 77 has a mediation function of mediating information to be presented to the driver, and a data generation function of generating video data and voice data based on the mediation result.

As the mediation function, the presentation controller 77 sets priority for each content to be a presentation candidate based on various acquired information acquired by the information acquisition unit 71. The presentation controller 77 selects the content determined to have a high priority as a target to be provided to the driver. As the data generation function, the presentation controller 77 generates a control signal and video data to be provided to each display device and a control signal and voice data to be provided to the audio device 24 based on the result of selecting the content.

The automated driving ECU 50b and the HCU 100 temporarily permit the driver to execute an act other than driving. More specifically, in an automated driving period during which the vehicle A autonomously travels by the automated driving function at Level 3 by the automated driving ECU 50b, the driver can be permitted to perform a specific act (hereinafter, second task) that is defined in advance, the specific act other than driving.

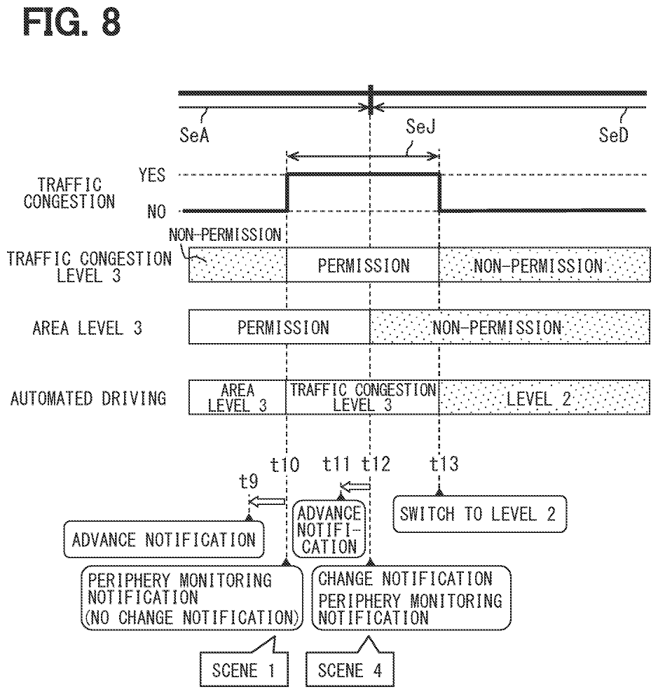

The driver may be legally permitted to perform a second task until a request to perform a driving operation by the automated driving system 50, that is a request to switch the driving operation (i.e., Take Over Request, see time t13 in FIG. 8) is made. The second task can be called a secondary activity, other activity, or the like. The second task must not prevent a driver from responding to a request to take over the driving operation from the automated driving system 50. For example, watching entertainment content such as video content, operating a device such as a smartphone, eating a meal, and the like are assumed as second tasks.

In a period in which the second task described above is allowed, the presentation controller 77 controls that an automated driving status that presents information related to the eyes-off automated driving is displayed. The automated driving status may be displayed on a display device (for example, CID 22) that displays the video content, or may be displayed on a display device (for example, the meter display 21) different from the video content. As an example, the automated driving status is a bird's-eye view display mainly including an image in which traveling environment around the vehicle is reproduced by a vehicle icon, the other vehicle icon, a lane image, and the like. The presentation controller 77 additionally displays a message window, an icon, and the like on the automated driving status to perform a change notification, an advance notification, a periphery monitoring notification, and the like. The change notification, the advance notification, and the periphery monitoring notification may include reproduction of a message or a notification sound by the audio device 24.

The change notification is a notification indicating a state change of the execution pattern of the eyes-off automated driving. The change notification is performed when the state of the execution pattern changes while the automated driving is continued. The change in the state of the execution pattern means the switching of the permission state of the traffic congestion level 3 under the permission state of the area level 3 and the switching of the permission state of the area level 3 under the permission state of the traffic congestion level 3. Therefore, four state change scenes of the execution pattern are set in the presentation controller 77.

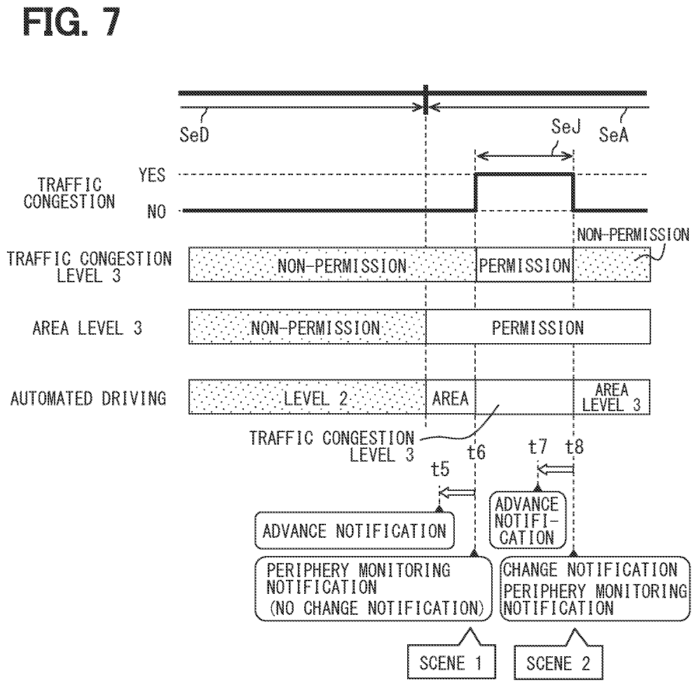

A first scene (hereinafter, scene 1) is a scene in which the traffic congestion level 3 becomes the permission state while the area level 3 continues, and the control is switched from the area level 3 to the traffic congestion level 3 (see time t6 in FIG. 7 and time t10 in FIG. 8). A second scene (hereinafter, scene 2) is a scene in which the traffic congestion level 3 is set to a non-permission state in the permission area SeA, and the control is switched from the traffic congestion level 3 to the area level 3 (see time t8 in FIG. 7). A third scene (hereinafter, scene 3) is a scene in which the area level 3 transitions to the permission state in a background as the vehicle enters the permission area SeA while the traffic congestion level 3 continues (see time t3 in FIG. 6). In scene 3, after entering the permission area SeA, switching of control from the traffic congestion level 3 to the area level 3 is scheduled as in scene 2. A fourth scene (hereinafter, scene 4) is a scene in which the area level 3 transitions to the non-permission state in the background in accordance with an exit from the permission area SeA while the traffic congestion level 3 continues (see time t12 in FIG. 8). The presentation controller 77 omits the change notification in scene 1 in which the control is switched from the area level 3 to the traffic congestion level 3 among scenes 1 to 4 of the state change described above.

The advance notification is a notification indicating a schedule of the state change of the execution pattern before the change notification. The advance notification is started at a timing earlier than the change notification by a predetermined time (for example, about several seconds), and is ended before a start of the change notification. The advance notification is also performed in scene 1 in which the change notification is omitted.

The periphery monitoring notification is content for performing notification for prompting the driver to monitor the periphery. Similarly to the change notification described above, the periphery monitoring notification is performed in each scene in which the execution pattern changes from one of the area level 3 and the traffic congestion level 3 to the other. In scene 1 in which the execution pattern changes from the area level 3 to the traffic congestion level 3, the presentation controller 77 highlights the periphery monitoring notification more than in scene 2 in which the execution pattern changes from the traffic congestion level 3 to the area level 3. Further, the presentation controller 77 highlights the periphery monitoring notification in scene 4 in which the vehicle exits the permission area SeA while continuing the traffic congestion level 3, more than in scene 3 in which the vehicle enters the permission area SeA while continuing the traffic congestion level 3.

The presentation controller 77 highlights the periphery monitoring notification by increasing information amount of traffic congestion information to be additionally displayed as the periphery monitoring notification in the automated driving status. More specifically, in the highlight of the periphery monitoring notification in scene 1, a display change of increasing the number of other vehicle icons to be displayed in the automated driving status is performed. In the highlight of the periphery monitoring notification in scene 4, a display change for notifying a traffic-congestion end position is performed based on the traffic congestion information received by the V2X communication device 39. For example, a message such as “Traffic congestion section will end soon” is additionally displayed in the automated driving status. In the highlighting described above, a display change or the like for expanding a range of the bird's-eye view display may be performed together. On the other hand, in scene 2 and scene 3 in which the periphery monitoring notification is not highlighted, the information amount of the traffic congestion information is reduced. With such a display change, the presentation controller 77 suggests to the occupant that the occupant is scheduled to exit the traffic congestion section SeJ while simplifying display content of the automated driving status.

Next, details of the control in each scene in which the state of the execution pattern of the eyes-off automated driving changes will be described below with reference to FIGS. 1 and 2 based on FIGS. 6 to 8.

In series of scenes shown in FIG. 6, the vehicle A enters the traffic congestion section SeJ in the restricted permission area SeD (time t1). The automated driving ECU 50b starts the eyes-off automated driving at the traffic congestion level 3 based on the congestion recognition by the traffic-congestion recognition unit 65 in the restricted permission area SeD. The automated driving ECU 50b enters the permission area SeA while continuing the eyes-off automated driving at the traffic congestion level 3 (time t3). The automated driving ECU 50b permits the execution of the eyes-off automated driving of the area level 3 based on an entry into the permission area SeA. The automated driving ECU 50b is set the traffic congestion level 3 to be not permitted when the automated driving ECU 50b recognizes that the traffic congestion around the vehicle is resolved in the permission area SeA (time t4). As a result, the execution pattern of the eyes-off automated driving is switched from the traffic congestion level 3 to the area level 3.

In response to the state change of the execution pattern described above, the presentation controller 77 sets each execution timing of the advance notification, the change notification, and the periphery monitoring notification. The presentation controller 77 sets time t3 at which the vehicle arrives at the permission area SeA as the start timing of the change notification and the periphery monitoring notification, instead of the time t4 at which the traffic congestion level 3 is switched to the area level 3 when the automated driving at the traffic congestion level 3 is continued after entering the permission area SeA. In other words, a notification of the state change in which the traffic congestion level 3 is not permitted is combined with a notification of the state change in which the area level 3 is permitted, and is performed when the vehicle enters the permission area SeA.

Further, the presentation controller 77 sets the start timing (time t2) of the advance notification to time t3. As described above, the presentation controller 77 starts the advance notification at time t2 and then starts the change notification and the periphery monitoring notification at time t3. That is, the change notification and the periphery monitoring notification that are originally performed at time t4 are output early at time t3 (scene 3). The change notification at the time t3 can notify that the vehicle A has entered the permission area SeA in addition to a notification of the state change of the execution pattern.

In series of scenes shown in FIG. 7, the vehicle A enters the traffic congestion section SeJ in the permission area SeA (time t6). The automated driving ECU 50b switches the execution pattern of the eyes-off automated driving from the area level 3 to the traffic congestion level 3 based on the congestion recognition by the traffic-congestion recognition unit 65. Further, at the timing (time t8) at which the vehicle A deviates from the traffic congestion section SeJ, the automated driving ECU 50b switches the execution pattern of the eyes-off automated driving from the traffic congestion level 3 to the area level 3 based on the recognition of congestion resolution by the traffic-congestion recognition unit 65.

The presentation controller 77 sets each execution timing of the advance notification, the change notification, and the periphery monitoring notification based on a state change schedule of the above-described execution pattern grasped by the automated-driving grasping unit 72. More specifically, the presentation controller 77 sets a start timing of the advance notification (time t5, t7) a predetermined time before each of the times t6 and t8 at which the control is switched between the area level 3 and the traffic congestion level 3. Based on such settings, the presentation controller 77 starts the advance notification at time t5, and then starts the periphery monitoring notification in a highlight mode at time t6 (scene 1). At this time t6, the change notification is omitted. Further, after starting the advance notification at time t7, the presentation controller 77 starts the periphery monitoring notification in a normal mode at time t8 (scene 2).

In series of scenes shown in FIG. 8, the vehicle A enters the traffic congestion section SeJ in the permission area SeA (time t10). The automated driving ECU 50b switches the execution pattern of the eyes-off automated driving from the area level 3 to the traffic congestion level 3 based on the congestion recognition in the permission area SeA. The automated driving ECU 50b exits the permission area SeA while continuing the eyes-off automated driving at the traffic congestion level 3 (time t12). Further, when the automated driving ECU 50b recognizes that traffic congestion around the vehicle has been relieved in the restricted permission area SeD, the eyes-off automated driving is ended, and the automated driving is switched to the automated driving with the periphery monitoring notification (time t13).

The presentation controller 77 sets each execution timing of the advance notification, the change notification, and the periphery monitoring notification based on the state change schedule of the above-described execution pattern. More specifically, the presentation controller 77 sets a start timing of the advance notification (time t9, t11) a predetermined time before each of the time t10 at which the control is switched from the area level 3 to the traffic congestion level 3 and the time t12 at which the vehicle exits the permission area SeA. Based on such settings, the presentation controller 77 starts the advance notification at time t9 and then starts the periphery monitoring notification in the normal mode at time t10 (scene 1). Further, the presentation controller 77 starts the advance notification at time t11 and then starts the change notification and the periphery monitoring notification in a highlight mode at time t12 (scene 4). The change notification described above can notify that the vehicle A has left the permission area SeA in addition to notifying that the state of the execution pattern has changed.

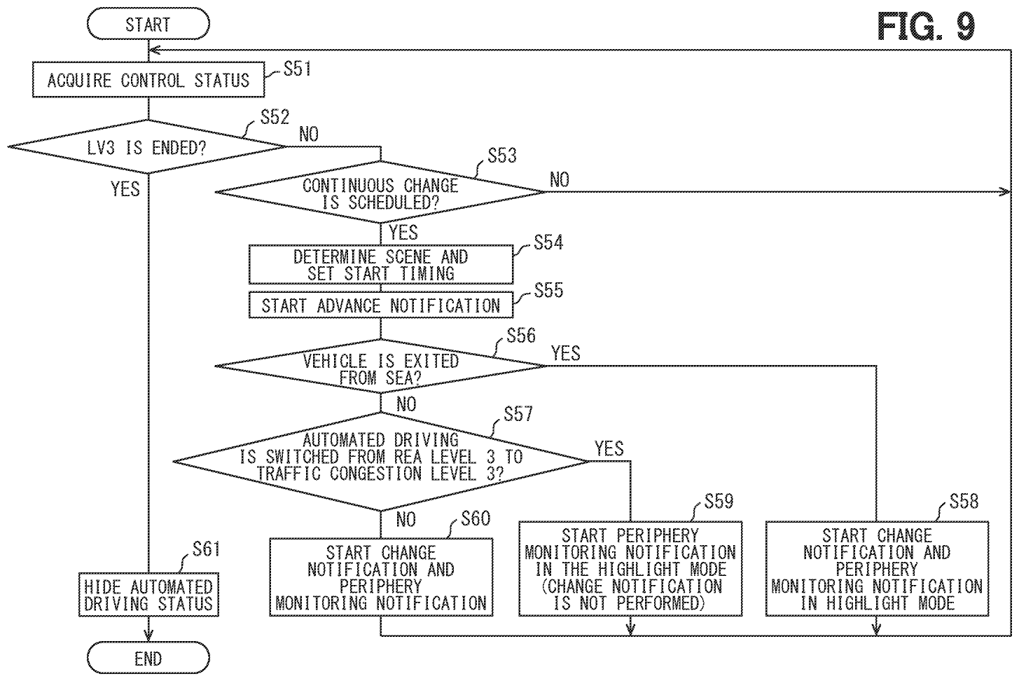

Next, details of a notification control process for controlling each notification described above will be described below with reference to FIGS. 1, 2, and 6 to 8 based on FIG. 9. The notification control process is started by the automated-driving grasping unit 72 and the presentation controller 77 based on that the eyes-off automated driving is started in the automated driving ECU 50b, and is continued until the eyes-off automated driving is ended.

In step S51, the latest control status information is acquired, a state of the execution of the eyes-off automated driving in the automated driving ECU 50b is grasped, and the process proceeds to step S52. In step S52, it is determined whether the eyes-off automated driving ends based on the execution state of the eyes-off automated driving grasped in step S51. When it is determined in step S51 that the eyes-off automated driving is to be ended, the process proceeds to step S61. In step S61, the automated driving status displayed on the display is hidden, and the notification control process ends. In step S61, a driving change request to the driver may be performed.

On the other hand, when it is determined in step S52 that the eyes-off automated driving is to be continued, the process proceeds to step S53. In step S53, it is determined whether a continuous change in a state of the execution pattern is scheduled. When it is determined that the continuous change of the state of the execution pattern is not scheduled, the process returns to step S51. In this case, by repeating steps S51 to S53, occurrence of the continuous change in the execution pattern is waited for. When it is determined in step S53 that there is the continuous change in the execution pattern, the process proceeds to step S54.

In step S54, a scene of the state change is determined and a start timing of each notification is set, and the process proceeds to step S55. In step S55, the advance notification is started based on the start timing set in step S54, and the process proceeds to step S56. In step S56, based on the scene determination result in step S54, it is determined whether the scene is a scene (scene 4) for exiting the permission area SeA. When it is determined in step S56 that the scene is an exit scene from the permission area SeA, the process proceeds to step S58. In step S58, the change notification and the periphery monitoring notification in the highlight mode are started at the timing when the vehicle A exits the permission area SeA, and the process returns to step S51.

On the other hand, in a case where it is determined in step S56 that the scene is not a scene for exiting the permission area SeA, the process proceeds to step S57. In step S57, it is determined whether it is a scene (scene 1) in which the control of the eyes-off automated driving is switched from the area level 3 to the traffic congestion level 3. In a case where it is determined in step S57 that the scene is a switching scene from the area level 3 to the traffic congestion level 3, the process proceeds to step S59. In step S59, the periphery monitoring notification in the highlight mode is started at a timing when the control of the automated driving is switched, and the process returns to step S51. When a level is changed from the area level 3 to the traffic congestion level 3, the change notification notifying that the execution pattern is changed is not performed.

Further, in a case where it is determined in step S57 that it is not a scene of switching from the area level 3 to the traffic congestion level 3, the process proceeds to step S60. In step S60, based on the start timing set in step S54, the change notification for notifying the state change from the traffic congestion level 3 to the area level 3 and the periphery monitoring notification in the normal mode are started, and the process returns to step S51. The change notification and the periphery monitoring notification in step S60 are performed at a timing when the vehicle A enters the permission area SeA (scene 3) or at a timing when the traffic congestion level 3 ends in the permission area SeA (scene 2).

According to the first embodiment described above, even if execution patterns are included in the eyes-off automated driving in which the driver is not obliged to monitor the surroundings, the occupant such as the driver can perceive the state of the current execution pattern in the automated driving system 50 by the change notification. According to the above, since the driver can easily grasp what kind of automated driving is performed, convenience of automated driving can be ensured.

In addition, in the first embodiment, the state change of the execution pattern from the traffic congestion level 3, which is implemented only during traveling in traffic congestion, to the area level 3, which is implemented only in the permission area SeA, is notified (see scene 3 in FIG. 6 and scene 2 in FIG. 7). Therefore, even when the vehicle A automatically accelerates after exiting from the traffic congestion section SeJ, the occupant is less likely to feel uneasy about behavior change of the vehicle A because the occupant is aware of the switching of the control.

In addition, in the first embodiment, in a case where the eyes-off automated driving at the traffic congestion level 3 is continued after the entry into the permission area SeA, the change notification is performed early, and the entry into the permission area SeA is notified during a duration of the traffic congestion level 3. More specifically, the change notification is performed at the timing of entering the permission area SeA (see scene 3 in FIG. 6). The change notification can notify the occupant of not only the state change of the execution pattern but also the entry of the vehicle A into the permission area SeA. In this way, if a plurality of pieces of information can be notified by a single change notification, annoyance of information presentation can be reduced. As a result, since the second task performed by the occupant is less likely to be disturbed, the convenience is further improved.

Further, in the first embodiment, the notification of the state change of the execution pattern from the area level 3 to the traffic congestion level 3 is omitted (see scene 1 in FIG. 7). In a scene in which the control of the automated driving is switched from the area level 3 to the traffic congestion level 3, only a transition to a low-speed autonomous traveling is performed, and thus the occupant is less likely to feel uneasy. Therefore, since the change notification is omitted and priority is given to reducing the annoyance, the second task can be easily continued. Therefore, the convenience can be further improved.

In addition, in the first embodiment, change schedule of the execution pattern is notified in advance before the change notification for notifying the state change of the execution pattern. According to such the advance notification, the occupant is less likely to miss the change notification in the execution pattern, and thus can more reliably perceive the state of the current execution pattern. Therefore, highly convenient change notification is realized.

Further, in the first embodiment, when the execution pattern of the automated driving changes between the area level 3 in which the automated driving is implemented only in the permission area SeA and the traffic congestion level 3 in which the automated driving is implemented only in the traveling in the traffic congestion, the occupant such as the driver is prompted to implement the periphery monitoring. If the notification prompting the surrounding monitoring is performed without the surrounding monitoring obligation, the occupant can easily perceive the current state of the execution pattern. As a result, the occupant can flexibly respond to the change in the vehicle behavior caused by the state change of the execution pattern. Therefore, the convenience of automated driving can be ensured.

Further, in the first embodiment, the execution of the surroundings monitoring is prompted in a scene in which acceleration and deceleration are assumed by a change in the execution pattern. In this way, when a part of consciousness of the occupant is directed to driving by performing the periphery monitoring, anxiety about acceleration and deceleration is less likely to be caused.

In addition, in the first embodiment, even when it is recognized that the driver does not perform the periphery monitoring, the automated driving ECU 50b is allowed to change the execution pattern. In this way, by keeping the execution of the periphery monitoring to recommendation, switching control of the execution pattern from becoming complicated can be avoided. As a result, the automated driving in which convenience is ensured can be performed.

In the first embodiment, the periphery monitoring notification in scene 1 in which the area level 3 changes to the traffic congestion level 3 is highlighted more than the periphery monitoring notification in scene 2 in which the traffic congestion level 3 changes to the area level 3. According to the above, since overlooking of the periphery monitoring notification can be reduced, the occupant can perceive traveling in the traffic congestion section SeJ. As a result, even when a change in vehicle behavior occurs due to, for example, an interruption of a side vehicle from an adjacent lane, the anxiety of the occupant can be reduced.

Further, in the first embodiment, in a scene in which the area level changes from the area level 3 to the traffic congestion level 3, information amount of traffic congestion information provided to the driver is increased. By highlighting the traffic congestion information by increasing the information amount, the driver can more easily recognize traveling environment around the vehicle. Therefore, highly convenient periphery monitoring notification is realized.

In addition, in the first embodiment, in a scene in which a level changes from the traffic congestion level 3 to the area level 3, the information amount of the traffic congestion information provided to the driver is reduced. According to simplification of the traffic congestion information, the driver can easily understand the periphery monitoring notification. Therefore, highly convenient periphery monitoring notification is realized.

Further, in the first embodiment, when the vehicle A exits the permission area SeA while continuing the automated driving at the traffic congestion level 3, the presentation controller 77 highlights the content of the periphery monitoring notification. In such a scene, after exiting from the permission area SeA, the eyes-off automated driving ends together with an end of the traffic congestion section SeJ. Therefore, the periphery monitoring notification is performed during continuation of the eyes-off automated driving to make the occupant aware of the driving at an early stage, so that the driving change can be smoothly performed.

In the above embodiment, the automated-driving grasping unit 72 corresponds to a state grasping unit, the presentation controller 77 corresponds to a state notification unit and a monitoring promotion unit, the permission area SeA corresponds to a specific area, and the HCU 100 corresponds to a presentation control device. Further, the automated driving control at the traffic congestion level 3 corresponds to congestion limiting control, and the automated driving control at the area level 3 corresponds to area limiting control.

### Second Embodiment

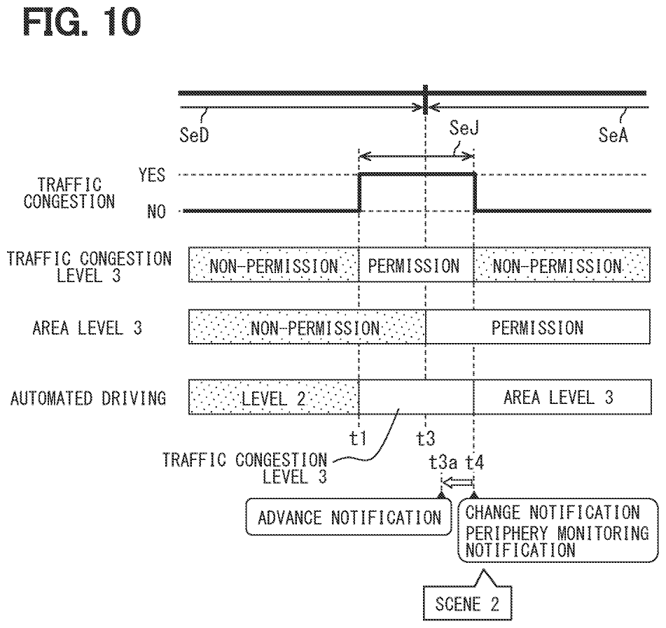

A second embodiment of the present disclosure shown in FIG. 10 is a modification of the first embodiment. In series of scenes shown in FIG. 10, an automated driving ECU 50b continues an automated driving at a traffic congestion level 3 after entering a permission area SeA, and switches an automated driving control from the traffic congestion level 3 to an area level 3 at time t4.

A presentation controller 77 sets time t4 at which an execution pattern is switched from the traffic congestion level 3 to the area level 3 as an execution timing of a change notification and a periphery monitoring notification. Further, the presentation controller 77 sets time t3a, which is a predetermined time before time t4, as the execution timing of an advance notification.

As described above, the presentation controller 77 does not perform the change notification and the periphery monitoring notification at a timing of entering the permission area SeA (time t3). After entering the permission area SeA, the presentation controller 77 starts the advance notification at time t3a. The presentation controller 77 performs a change notification for notifying a state change of the execution pattern from the traffic congestion level 3 to the area level 3 and the periphery monitoring notification at a timing (time t4) at which the automated driving of the traffic congestion level 3 ends.

In the second embodiment described above, when the vehicle enters the permission area SeA in a state of the traffic congestion level 3, a notification corresponding to scene 3 (see FIG. 6) of the first embodiment is omitted, and a notification of scene 2 is performed. Also in the second embodiment, the same effects as that of the first embodiment is obtained, and an occupant can grasp a state of the current execution pattern in an automated driving system 50. Therefore, convenience of automated driving can be ensured.

In addition, in the second embodiment, the change notification after entering the permission area SeA is performed at an end timing of the traffic congestion level 3. Such the change notification can notify the occupant of an occurrence of change in a vehicle behavior accompanying control switching from the traffic congestion level 3 to the area level 3 at an appropriate timing. Therefore, highly convenient information presentation leading to a sense of security of the occupant is realized.

### Third Embodiment

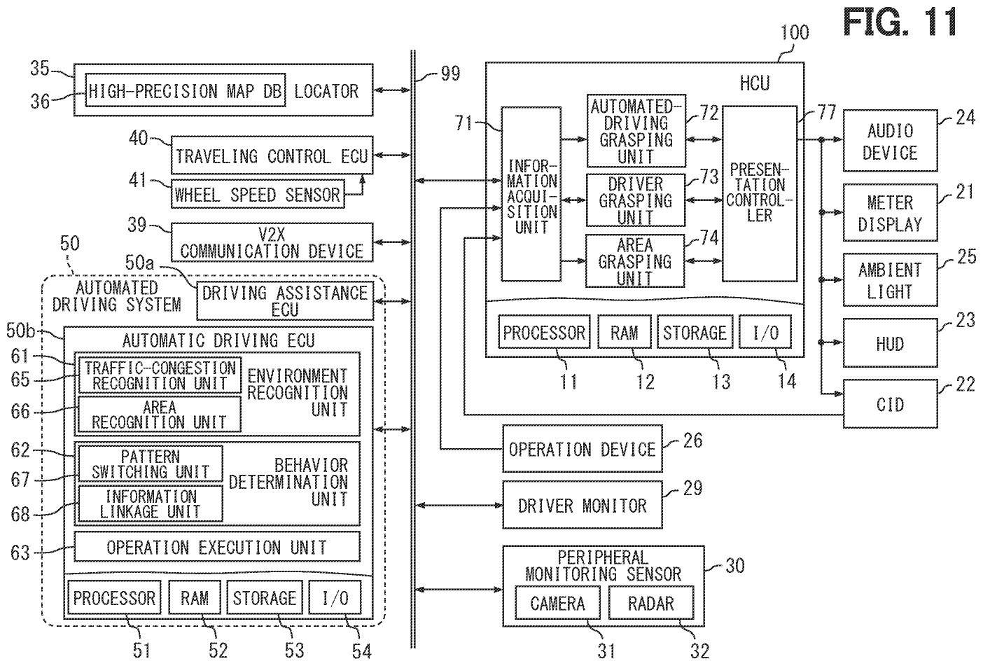

A third embodiment of the present disclosure shown in FIGS. 11 to 13 is another modification of the first embodiment. In the third embodiment, in a scene in which a vehicle travels in a non-permission area SeM (see FIG. 12), information presentation for preventing a driver from misunderstanding that an eyes-off automated driving is enabled is performed. In order to realize such information presentation, an HCU 100 further includes an area grasping unit 74 as a functional unit based on a presentation control program. Hereinafter, details of an automated-driving grasping unit 72, an area grasping unit 74, and a presentation controller 77 provided in the HCU 100 of the third embodiment will be described in order.

The automated-driving grasping unit 72 grasps, based on control status information acquired by an information acquisition unit 71, whether the traffic congestion around the vehicle is recognized by a traffic-congestion recognition unit 65 of an automated driving ECU 50b. Further, the automated-driving grasping unit 72 grasps an implementation schedule up to a predetermined time ahead based on the control status information in addition to the execution pattern of an autonomous traveling control currently being implemented. Accordingly, the automated-driving grasping unit 72 grasps a switching schedule of the execution pattern to be executed among execution patterns included in an eyes-off automated driving.

The area grasping unit 74 grasps that a road on which the vehicle is traveling and a road on which the vehicle is scheduled to travel is in which the non-permission area SeM, a restricted permission area SeD, and a permission area SeA based on the control status information acquired by the information acquisition unit 71. The area grasping unit 74 may grasp which area the road on which the vehicle is traveling and the road on which the vehicle is scheduled to travel are in based on locator information or three-dimensional map data provided from a locator 35 to the information acquisition unit 71. Thus, the area grasping unit 74 grasps a movement schedule from the non-permission area SeM to the permission area SeA or the restricted permission area SeD. In the following description, both the permission area SeA and the restricted permission area SeD may be collectively referred to as permission areas SeA, SeD.

The presentation controller 77 can use an ambient light 25 for information presentation in addition to display devices and an audio device 24. The ambient light 25 is provided on an instrument panel 9 (see FIG. 2), a steering wheel, and the like. The ambient light 25 presents information using a driver's peripheral vision by ambient display that changes a color of emitted light. The ambient light 25 notifies the driver, for example, by a change in the color of emitted light, that the eyes-off automated driving has become possible and that the eyes-off automated driving is scheduled to end.

As in the first embodiment, the presentation controller 77 performs a change notification, an advance notification, a periphery monitoring notification, and the like related to a switching of the execution pattern of the eyes-off automated driving. In addition, the presentation controller 77 performs a level 3 impossibility notification, a traffic congestion notification, the advance notification, a level 3 possibility notification, and the like as a notification related to an entry into the permission areas SeA, SeD. The presentation controller 77 additionally displays a message window, an icon, and the like in the automated driving status, thereby performing the level 3 impossibility notification, the traffic congestion notification, the advance notification, the level 3 possibility notification, and the like. These notifications may include output of a message or notification sound by the audio device 24. Note that, for convenience, the advance notification (see time t2 and the like in FIG. 6) performed prior to the switching of the execution pattern is referred to as a switching advance notification, and the advance notification performed in accordance with an approach to the permission areas SeA, SeD is referred to as an area advance notification.

The level 3 impossibility notification and the traffic congestion notification are performed when the traffic-congestion recognition unit 65 recognizes the traffic congestion state around the vehicle in a situation where the vehicle A is traveling in the non-permission area SeM and the movement schedule to the permission areas SeA, SeD is recognized. Even when the movement schedule to the permission areas SeA, SeD is grasped, if the surroundings of the vehicle are not in the traffic congestion state, the presentation controller 77 does not perform the level 3 impossibility notification and the traffic congestion notification.

The level 3 impossibility notification is a notification indicating that traveling in the eyes-off automated driving is not permitted because the vehicle is still traveling in the non-permission area SeM before entering the permission areas SeA, SeD. The level 3 impossibility notification clearly indicates to the driver that a function of the eyes-off automated driving is not yet enabled. In the level 3 impossibility notification, for example, a message such as “2nd task is unavailable” is additionally displayed in the automated driving status of the meter display 21. The level 3 impossibility notification has a function of preventing the driver from misunderstanding that the eyes-off automated driving can be used in a scene in which the vehicle approaches the permission areas SeA, SeD.

The traffic congestion notification is performed together with the level 3 impossibility notification, and is a notification indicating that the surroundings of the vehicle are congested. The traffic congestion notification clearly indicates to the driver that the automated driving system 50 correctly recognizes the traffic congestion around the vehicle, and thus exerts a function of eliminating a suspicion of the driver that a reason the eyes-off automated driving cannot be used is that the automated driving system 50 cannot recognize the traffic congestion.

The area advance notification is a notification indicating to the driver that the area grasping unit 74 grasps the movement schedule to the permission areas SeA, SeD. The presentation controller 77 grasps a scheduled entry time into the permission areas SeA, SeD and starts the area advance notification at a timing earlier than the scheduled entry time by a predetermined time (for example, about several seconds). The presentation controller 77 ends the area advance notification before the vehicle A enters the permission areas SeA, SeD.

The presentation controller 77 makes a mode of the switching advance notification (see the time t2 and the like in FIG. 6) in a case where a state of the execution pattern of the eyes-off automated driving changes different from a mode of the area advance notification described above. The presentation controller 77 sets information amount to be provided to the driver in the area advance notification to be larger than the information amount to be provided to the driver in the switching advance notification.

More specifically, the number of contents (images) presented in the area advance notification is made larger than the number of contents presented in the switching advance notification. As an example, in the switching advance notification, a change of the icon displayed in the automated driving status notifies in advance a switching of the execution pattern between the traffic congestion level 3 and the area level 3. On the other hand, in the area advance notification, for example, a message window saying “2nd task will be available soon” and a blinking icon indicating a second task are additionally displayed in the automated driving status, and thus an entry into the permission areas SeA, SeD is notified in advance.

In addition, the presentation controller 77 makes the information amount of the area advance notification larger than the information amount of the switching advance notification by making a display duration time of the area advance notification longer than the display duration time of the switching advance notification. In addition, the presentation controller 77 sets a start timing of the area advance notification to be later than the start timing of the switching advance notification. As described above, the area advance notification is started a predetermined time (hereinafter, a first start time) before a scheduled entry time from the non-permission area SeM to the permission area SeA, and is ended a predetermined time (hereinafter, a first end time) before the scheduled entry time. On the other hand, the switching advance notification is started a predetermined time (hereinafter, a second start time) before a scheduled movement time from one of the permission area SeA and the restricted permission area SeD to the other, and is ended a predetermined time (hereinafter, the second end time) before the scheduled movement time. The presentation controller 77 sets the second start time to be longer than the first start time and sets the second end time to be longer than the first end time. Further, the presentation controller 77 sets a period from the first start time to the first end time to be longer than a period from the second start time to the second end time. With the above setting, the area advance notification is started later than the switching advance notification and is continued longer than the switching advance notification.

The level 3 possibility notification is a notification indicating to the driver that a function of the eyes-off automated driving has become available. The presentation controller 77 performs the level 3 possibility notification based on recognition of the entry into the permission areas SeA, SeD. In the level 3 possibility notification, for example, a message such as “2nd task becomes available” is additionally displayed in the automated driving status of the meter display 21.

Next, a specific scene in which each notification described above is performed will be described. In FIG. 12, for example, a scene in which the vehicle passes through an ETC (registered trademark) gate serving as an entrance of an expressway and enters a main road of the expressway. The main road of the expressway is the restricted permission area SeD in which a function of the traffic congestion level 3 can be permitted. The main road may be the permission area SeA. On the other hand, a ramp way from the ETC gate to the main road is the non-permission area SeM in which the eyes-off automated driving is prohibited.

In the scene shown in FIG. 12, the area grasping unit 74 grasps the movement schedule from the non-permission area SeM to the restricted permission area SeD based on a passage of the vehicle A through the ETC gate. Thereafter, the vehicle A enters the traffic congestion section SeJ while traveling on the ramp way (time t1). At this time, the function of the traffic congestion level 3 remains prohibited. The presentation controller 77 starts the level 3 impossibility notification and the traffic congestion notification based on congestion recognition by the traffic-congestion recognition unit 65 (time t2). The level 3 impossibility notification and the traffic congestion notification may be terminated after a predetermined time has elapsed, or may be continued until a start of the area advance notification.

The presentation controller 77 starts the area advance notification at a timing before the first start time of the scheduled entry time (time t4) into the restricted permission area SeD when the vehicle A approaches the main road (time t3). The area advance notification is continued until a timing before the first end time of the scheduled entry time. A start and end of the area advance notification may be controlled based on a distance to the restricted permission area SeD. That is, the area advance notification may be started at a position a predetermined distance (for example, several hundred meters) before an entry position into the restricted permission area SeD, and may be ended at a position a predetermined distance (for example, several tens of meters) before the entry position.

Further, when the vehicle A enters the main road, the automated driving ECU 50b that has recognized the entry into the restricted permission area SeD permits the function of the traffic congestion level 3 (time t4). Based on the control status information, the presentation controller 77 recognizes that the function of the traffic congestion level 3 is permitted, and starts the level 3 possibility notification (time t5). After the execution of the level 3 possibility notification, the autonomous traveling control at the traffic congestion level 3 is started based on a driver operation or automatically.

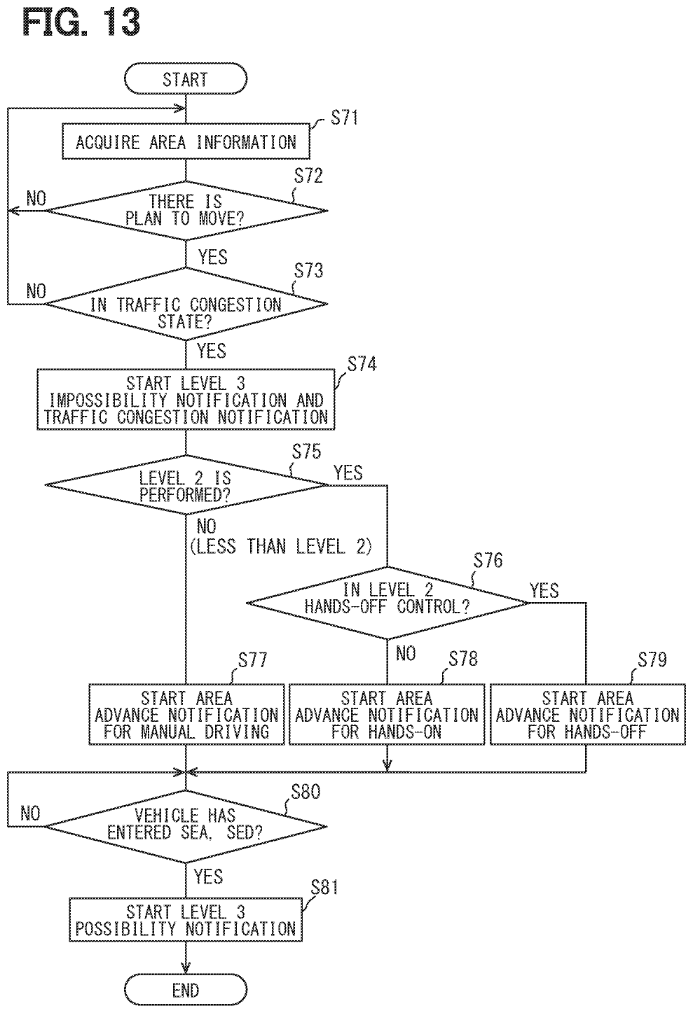

Next, details of a notification control process for controlling each notification described above will be described below with reference to FIGS. 11 and 12 based on FIG. 13. The notification control process is started by the HCU 100 based on a start of traveling of the vehicle A, and is continuously performed during a period in which the eyes-off automated driving is not performed.

In step S71, area information is acquired based on the control status information, the three-dimensional map data, or the like, and the process proceeds to step S72. The area information is information indicating whether the road on which the vehicle is traveling and the road on which the vehicle is scheduled to travel are areas in which the eyes-off automated driving is permitted. In step S72, based on the area information acquired in step S71, it is determined whether there is a plan to move from the non-permission area SeM to the permission areas SeA, SeD. When it is determined in step S72 that there is no movement plan to the permission areas SeA, SeD, the process returns to step S71. On the other hand, in a case where it is determined in step S72 that the movement schedule to the permission area SeA, SeD is grasped, the process proceeds to step S73.

In step S73, it is determined whether the surroundings of the vehicle are in the traffic congestion state. In step S73, when it is determined that the surroundings of the vehicle are not in the traffic congestion state, the process returns to step S71. On the other hand, when it is determined in step S73 that the surroundings of the vehicle are in the traffic congestion state, the process proceeds to step S74. In step S74, the traffic congestion notification indicating that the vehicle is in the traffic congestion and the level 3 impossibility notification indicating that the vehicle is not permitted to travel by the eyes-off automated driving are performed, and the process proceeds to step S75.

In step S75, it is determined whether traveling by driving assistance control of an automatic driving level 2 is performed. In step S75, in a case where it is determined that the travel by the driving assistance control of the level 2 is not performed, in other words, the driving assistance control of automatic driving level 1 is performed or manual driving is being performed, the process proceeds to step S77. In step S77, the area advance notification (hereinafter, an area advance notification for manual driving) associated with a case where the driving assistance control of level 1 or the manual driving is performed is performed.

On the other hand, when it is determined in step S75 that the driving assistance control of level 2 is being performed, the process proceeds to step S76. In step S76, it is determined whether the driving assistance control being executed is hands-off control in which the driver is not obliged to grip the steering wheel. In step S76, when it is determined that the hands-off control is being performed, the process proceeds to step S79. In step S79, the area advance notification (hereinafter, an area advance notification for hands-off) associated with a case where the hands-off control is performed is performed. On the other hand, in step S76, when it is determined that the hands-on control in which the driver is obliged to grip the steering wheel is being performed, the process proceeds to step S78. In step S78, the area advance notification (hereinafter, an area advance notification for hands-on) associated with a case where the hands-on control is performed is performed.

The area advance notification for manual driving, the area advance notification for hands-off, and the area advance notification for hands-on have different modes from each other. For example, the area advance notification for the hands-off and the area advance notification for the hands-on are more highlighted than the area advance notification for the manual driving. The area advance notification for manual driving may be omitted. Furthermore, the area advance notification for hands-on may be more highlighted than the area advance notification for hands-off, or may be less conspicuous than the area advance notification for hands-off. As an example, among the area advance notifications for hands-on and hands-off, the notification by a change in an emission color of the ambient light 25 is performed only in the area advance notification for hands-off.

In step S80, it is determined whether the vehicle A has entered the permission areas SeA, SeD based on the latest locator information. In step S80, when it is determined that the vehicle A has entered the permission area SeA, SeD, the process proceeds to step S81. In step S81, the level 3 possibility notification is performed. Then, after the execution of the level 3 possibility notification, the series of notification control processes ends.

In the third embodiment described above, the same effects as those of the first embodiment are obtained, and the state of the current execution pattern in the automated driving system 50 can be easily grasped, so that convenience for automated driving can be secured.

More specifically, in the third embodiment, an output mode of the area advance notification indicating to the driver that the vehicle is scheduled to move to the permission areas SeA, SeD is different from an output mode of the switching advance notification indicating to the driver that the vehicle is scheduled to switch the execution pattern of the automated driving. Therefore, the area advance notification can be distinguished from the switching advance notification. Therefore, a situation in which the area advance notification performed while the vehicle is traveling in the non-permission area SeM in the traffic congestion state is mistakenly interpreted as enabling the automated driving without the surroundings monitoring obligation can be avoided.

In addition, in the third embodiment, the information mount provided to the driver in the area advance notification is larger than the information amount provided to the driver in the switching advance notification. Therefore, the area advance notification is more easily distinguished from the switching advance notification, and is information presentation in which the content is easily understood. According to the above, since a possibility that the area advance notification is erroneously recognized as a notification indicating that the eyes-off automated driving can be used can be further reduced, the convenience of the automatic driving is less likely to be impaired.

In the third embodiment, the start timing of the area advance notification is set to be later than the start timing of the switching advance notification. Thus, a time from the start of the area advance notification until the traffic congestion level 3 becomes available shortens. Therefore, even in a case where the driver assumes that it is possible to travel at the traffic congestion level 3 and continues to erroneously recognize the area advance notification as a notification indicating that the traffic congestion level 3 can be used, uncomfortable feelings of the driver can be reduced.

Further, in the third embodiment, when the movement schedule to the permission areas SeA, SeD is grasped during traveling in the non-permission area SeM in the traffic congestion state, the level 3 impossibility notification and the traffic congestion notification are performed. Then, by the level 3 impossibility notification and the traffic congestion notification, the driver is clearly notified that the traveling by the eyes-off automated driving is not permitted. Therefore, a situation in which the vehicle is erroneously recognized as being able to travel by the eyes-off automated driving due to the traffic congestion state even before entering the permission areas SeA, SeD can be avoided.

In addition, in the third embodiment, when the surroundings of the vehicle are not in the traffic congestion state, the execution of the level 3 impossibility notification and the traffic congestion notification is omitted. In this way, in a scene in which a possibility of misrecognition by the driver is low, an inconvenience of information presentation can be reduced by omitting each notification.

In addition, in the third embodiment, the area advance notification for the hands-on in the case of shifting from the traffic congestion following to the traffic congestion level 3 in the hands-on control and the area advance notification for the hands-off in the case of shifting from the traffic congestion following to the traffic congestion level 3 in the hands-off control are performed in different modes. Therefore, in accordance with a state of each driver in the hands-on control and the hands-off control, the area advance notification that is easily recognized can be performed.

In the third embodiment, the presentation controller 77 corresponds to a notification control unit, and the level 3 impossibility notification and the traffic congestion notification correspond to a non-permission area notification. In addition to the permission area SeA, the restricted permission area SeD corresponds to a permission area.

### Other Embodiments

Although the embodiments of the present disclosure have been described above, the present disclosure should not be understood as being limited to the aforementioned embodiments. The present disclosure can be applied to various embodiments and various combinations thereof, without departing from the spirits of the present disclosure.

In a first modification of the above embodiment, an execution pattern of an automatic driving level 4 or higher is set in an automated driving ECU 50b. In the first modification, not only switching between a traffic congestion level 3 and an area level 3 but also switching between an automated driving of a level 3 and the automated driving of a level 4 is notified to a driver or the like by a change notification.

In a second modification of the above embodiment, in addition to a traffic congestion level 3 and an area level 3, an execution pattern of an automated driving of a level 3 is set. An automated driving ECU 50b of the second modification determines whether to perform an eyes-off automated driving based on a determination as to whether a vehicle is a motorway or an expressway, a determination as to whether there is a median strip, and the like in addition to a vehicle speed and operation information of a driver monitor 29. The automated driving ECU 50b selects an execution pattern to be executed from execution patterns based on each determination result. The HCU 100 that cooperates with the automated driving ECU 50b sequentially notifies switching among three or more execution patterns including the traffic congestion level 3 and the area level 3. In the second modification, the execution pattern of at least one of the traffic congestion level 3 and the area level 3 may be omitted.

In a third modification of the above embodiment, in a permission area SeA, even in scene 1 in which an execution pattern is switched from an area level 3 to a traffic congestion level 3, a change notification of the execution pattern is performed. In a fourth modification of the above embodiment, an advance notification is omitted.

In a fifth modification of the above embodiment, when both a traffic congestion level 3 and an area level 3 are in a permission state, control of the area level 3 is preferentially selected. Therefore, when a vehicle enters a permission area SeA by an automated driving of the traffic congestion level 3, the traffic congestion level 3 is continuously changed to the area level 3 (see scene 3 in FIG. 6). A presentation controller 77 performs a change notification and a periphery monitoring notification at time t3 at which the traffic congestion level 3 is switched to the area level 3. In the fifth modification, the change notification and the periphery monitoring notification at the time t4 at which the traffic congestion level 3 becomes a non-permission state in a background are not performed.

In a sixth modification of the above embodiment, a highlight of a periphery monitoring notification in scene 1 and scene 4 due to an increase in traffic congestion information is omitted. In addition, in the sixth modification, information amount of the traffic congestion information is maintained also in scene 2 and scene 3. That is, in each scene of the sixth modification, display content of an automated driving status is not substantially changed.

In a seventh modification of the above embodiment, a periphery monitoring notification in scene 2 in which an execution pattern is switched from a traffic congestion level 3 to an area level 3 is highlighted more than the periphery monitoring notification in scene 1 in which the execution pattern is switched from the area level 3 to the traffic congestion level 3. Such highlight of the periphery monitoring notification may be implemented by, for example, a change in display color and display brightness, animation display, additional display of a message window, and switching of a display device from a meter display 21 to a HUD 23. According to the seventh modification described above, the highlight of the periphery monitoring notification easily conveys to the driver that an autonomous traveling is an autonomous traveling of the area level 3 in which a traveling speed is higher than a traffic congestion section SeJ and a possibility of a driving change due to a change in a surrounding situation is high.

In an eighth modification of the third embodiment, in a case where a vehicle A is traveling in a non-permission area SeM in a traffic congestion state and a movement schedule to a restricted permission area SeD is grasped, a presentation controller 77 omits an execution of an area advance notification. More specifically, when a traffic congestion is immediately resolved after a movement to the restricted permission area SeD, a start of an autonomous traveling control of the traffic congestion level 3 is difficult. In the eighth modification, in consideration of a fact that it is unclear how long the traffic congestion will continue, when a road ahead of the vehicle is the restricted permission area SeD, the area advance notification is stopped. As in the eighth modification described above, the area advance notification and a switching advance notification may be different from each other by stopping the area advance notification.

In a ninth modification of the third embodiment, information amount of a switching advance notification is larger than that of an area advance notification. In a tenth modification of the third embodiment, a start timing of a switching advance notification is delayed from a start timing of an area advance notification. Further, in an eleventh modification of the above embodiment, when a schedule of movement to the permission areas SeA, SeD is grasped while traveling in a non-permission area SeM in a traffic congestion state, only a level 3 impossibility notification is performed among the level 3 impossibility notification and a traffic congestion notification.

In the above embodiments and modifications, the respective functions provided by the automated driving ECU and the HCU can be also provided by software and hardware for executing the software, only software, only hardware, and complex combinations of software and hardware. In cases where functions are provided by electronic circuits as hardware, the functions can be also provided by analog circuits or digital circuits which include a large number of logic circuits.

Each of the processing units of the above-described embodiments may be individually mounted on a printed circuit board, or may be mounted on an ASIC (Application Specific Integrated Circuit), a FPGA, or the like. The storage medium (non-transitory tangible computer-readable storage medium or non-transitory tangible storage medium) that stores the program for implementing the above-described presentation control method may be changed as appropriate. For example, the storage medium is not limited to the configuration provided on the circuit board, and may be provided in the form of a memory card or the like. The storage medium may be inserted into a slot portion, and electrically connected to the control circuit of the HCU. The storage medium may include an optical disk which forms a source of programs to be copied into a HCU, a hard disk drive therefor, and the like.

The vehicle equipped with the HMI system is not limited to a general private car, but may be a rented vehicle, a vehicle for man-driving taxi, a vehicle for sharing vehicle service, a freight vehicle, a bus, or the like. An HMI system including the HCU may be mounted on a vehicle dedicated to unmanned driving used for mobility services.

The vehicle equipped with the HMI system may be a right-hand drive vehicle or a left-hand drive vehicle. Further, the traffic environment in which the vehicle travels may be a traffic environment premised on left-hand traffic, or may be a traffic environment premised on right-hand traffic. According to the present disclosure, the display of each content for the driving assistance is appropriately optimized according to the road traffic law of each country and region, the steering wheel position of the vehicle, and the like.

The control unit and the method thereof which have been described in the present disclosure may be also implemented by a special purpose computer which includes a processor programmed to execute one or more functions implemented by computer programs. Alternatively, the control unit and the control method described in the present disclosure may be implemented by a special purpose hardware logic circuit. Alternatively, the control unit and the control method described in the present disclosure may be implemented by one or more special purpose computers configured by a combination of a processor executing a computer program and one or more hardware logic circuits. The computer program may be stored, as instructions to be executed by a computer, in a tangible non-transitory computer-readable medium.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A presentation control device for a vehicle having an automated driving function capable of performing automated driving without driver's obligation to monitor surroundings, the presentation control device being configured to control presentation of information related to the automated driving, the presentation control device comprising:
a state grasping unit configured to grasp an execution pattern state selected from among execution patterns in the automated driving function, the execution patterns being included in the automated driving without the driver's obligation to monitor the surroundings; and
a state notification unit configured to notify a change of the execution pattern state when the execution pattern state changes while the automated driving without the driver's obligation to monitor the surroundings is continued, wherein
the state notification unit is configured to notify a schedule of the change of the execution pattern state in advance before notifying the change of the execution pattern state.

2. The presentation control device according to claim 1, wherein
the state grasping unit is configured to grasp a switching of the execution pattern state from congestion-limited control executed only for traveling in a traffic congestion section to area-limited control executed only for a specific area, and
the state notification unit is configured to notify the change of the execution pattern state when the congestion-limited control is switched to the area-limited control.

3. A presentation control device for a vehicle having an automated driving function capable of performing automated driving without driver's obligation to monitor surroundings, the presentation control device being configured to control presentation of information related to the automated driving, the presentation control device comprising:
a state grasping unit configured to grasp an execution pattern state selected from among execution patterns in the automated driving function, the execution patterns being included in the automated driving without the driver's obligation to monitor the surroundings; and
a state notification unit configured to notify a change of the execution pattern state when the execution pattern state changes while the automated driving without the driver's obligation to monitor the surroundings is continued, wherein
the state grasping unit is configured to grasp a switching of the execution pattern state from congestion-limited control executed only for traveling in a traffic congestion section to area-limited control executed only for a specific area, and
the state notification unit is configured to notify the change of the execution pattern state when the congestion-limited control is switched to the area-limited control.

4. The presentation control device according to claim 2, wherein
the state grasping unit is configured to grasp an entry into the specific area by the automated driving under the congestion-limited control, and
the state notification unit is configured to notify the entry into the specific area during a duration of the congestion-limited control in a case where the automated driving by the congestion-limited control is continued after the entry into the specific area.

5. The presentation control device according to claim 2, wherein
the state grasping unit is configured to grasp an entry into the specific area by the automated driving under the congestion-limited control, and
the state notification unit is configured to notify the change of the execution pattern state at a timing at which the congestion-limited control is ended after the entry into the specific area.

6. The presentation control device according to claim 2, wherein
the state grasping unit is configured to grasp a switching of the execution pattern state from the area-limited control to the congestion-limited control, and
the state notification unit is configured to omit notification of the change of the execution pattern state when the area-limited control is switched to the congestion-limited control.

7. A non-transitory computer readable medium storing a computer program comprising instructions configured to be executed by a processor, the computer program being for a vehicle having an automated driving function capable of performing automated driving without driver's obligation to monitor surroundings, the computer program being for control of presentation of information related to the automated driving, the instructions, when executed by the processor, causing the processor to:
grasp an execution pattern state selected from among execution patterns in the automated driving function, the execution patterns being included in the automated driving without the driver's obligation to monitor the surroundings; and
notify a change of the execution pattern state when the execution pattern state changes while the automated driving without the driver's obligation to monitor the surroundings is continued; and
notify a schedule of the change of the execution pattern state in advance before notifying the change of the execution pattern state.

8. A non-transitory computer readable medium storing a computer program comprising instructions configured to be executed by a processor, the computer program being for a vehicle having an automated driving function capable of performing automated driving without driver's obligation to monitor surroundings, the computer program being for control of presentation of information related to the automated driving, the instructions, when executed by the processor, causing the processor to:
grasp an execution pattern state selected from among execution patterns in the automated driving function, the execution patterns being included in the automated driving without the driver's obligation to monitor the surroundings;
grasp a switching of the execution pattern state from congestion-limited control executed only for traveling in a traffic congestion section to area-limited control executed only for a specific area;
notify a change of the execution pattern state when the execution pattern state changes while the automated driving without the driver's obligation to monitor the surroundings is continued; and
notify the change of the execution pattern state when the congestion-limited control is switched to the area-limited control.

9. A presentation control device for a vehicle having an automated driving function capable of performing automated driving without driver's obligation to monitor surroundings, the presentation control device being configured to control presentation of information related to the automated driving, the presentation control device comprising:
a state grasping unit configured to grasp an execution pattern state selected from among execution patterns in the automated driving function, the execution patterns including area-limited control executed only for a specific area and congestion-limited control executed only for traveling in a traffic congestion section; and
a monitoring promotion unit configured to notify to prompt the driver to monitor the surroundings when the execution pattern state of the automated driving is switched from one of the area-limited control and the congestion-limited control to the other.

10. The presentation control device according to claim 9, further comprising
a driver grasping unit configured to grasp whether the driver is monitoring surroundings, wherein
the presentation control device controls that a switching of the execution pattern state in the automated driving function is permitted even when the driver grasping unit is configured to grasp that the driver is not monitoring the surroundings.

11. The presentation control device according to claim 9, wherein
the monitoring promotion unit is configured to set a degree of emphasis on a notification in a scene in which the execution pattern state is switched from the area-limited control to the congestion-limited control to be higher than a degree of emphasis on a notification in a scene in which the execution pattern state is switched from the congestion-limited control to the area-limited control.

12. The presentation control device according to claim 11, wherein
the monitoring promotion unit increases an information amount of traffic congestion information to be provided to the driver in a scene in which the execution pattern state is switched from the area-limited control to the congestion-limited control.

13. The presentation control device according to claim 11, wherein
the monitoring promotion unit maintains or reduces the information amount of the traffic congestion information to be provided to the driver in a scene in which the execution pattern state is switched from the congestion-limited control to the area-limited control.

14. The presentation control device according to claim 9, wherein
the monitoring promotion unit is configured to set a degree of emphasis on a notification in a scene in which the execution pattern state is switched from the congestion-limited control to the area-limited control to be higher than a degree of emphasis on a notification in a scene in which the execution pattern state is switched from the area-limited control to the congestion-limited control.

15. The presentation control device according to claim 9, wherein
the monitoring promotion unit is configured to highlight a content of a notification for prompting the driver to monitor the surroundings in a case where the vehicle leaves the specific area while continuing the automated driving by the congestion-limited control.

16. A non-transitory computer readable medium storing a computer program comprising instructions configured to be executed by a processor, the computer program being for a vehicle having an automated driving function capable of performing automated driving without driver's obligation to monitor surroundings, the computer program being for control of presentation of information related to the automated driving, the instructions, when executed by the processor, causing the processor to:
grasp an execution pattern state selected from among execution patterns in the automated driving function, the execution patterns being included area-limited control executed only for a specific area and congestion-limited control executed only for traveling in a traffic congestion section; and
notify to prompt the driver to monitor the surroundings when the execution pattern state of the automated driving is switched from one of the area-limited control and the congestion-limited control to the other.

17. A presentation control device configured to control presentation of information related to automated driving without driver's obligation to monitor surroundings, comprising:
a state grasping unit configured to grasp a switching schedule of execution patterns to be implemented, the execution patterns being included in the automated driving without the driver's obligation to monitor the surroundings;
an area grasping unit configured to grasp a movement schedule from a non-permission area in which traveling by the automated driving without the driver's obligation to monitor the surroundings is not permitted to a permission area in which traveling by the automated driving without the driver's obligation to monitor the surroundings is permitted; and
a notification control unit configured to perform a switching advance notification that indicates to the driver that the switching schedule of the execution patterns has been grasped during traveling by the automated driving without the obligation to monitor the surroundings, wherein
the notification control unit is configured to control that an output mode of an area advance notification is different from an output mode of the switching advance notification when the vehicle is traveling in the non-permission area in a traffic congestion state, the area advance notification indicating to the driver that the movement schedule to the permission area is recognized.

18. The presentation control device according to claim 17, wherein
the notification control unit is configured to set an information amount to be provided to the driver in the area advance notification to be larger than an information amount to be provided to the driver in the switching advance notification.

19. The presentation control device according to claim 17, wherein
the notification control unit is configured to set a start timing of the area advance notification to be later than a start timing of the switching advance notification.

20. The presentation control device according to claim 17, wherein
the notification control unit is configured to omit the area advance notification in a case where the vehicle is traveling in the non-permission area in a traffic congestion state.

21. A non-transitory computer readable medium storing a computer program comprising instructions configured to be executed by a processor, the computer program being for control of presentation of information related to automated driving without driver's obligation to monitor surroundings, the instructions, when executed by the processor, causing the processor to:
grasp a switching schedule of execution patterns to be implemented, the execution patterns being included in the automated driving without the driver's obligation to monitor the surroundings;
grasp a movement schedule from a non-permission area in which traveling by the automated driving without the driver's obligation to monitor the surroundings is not permitted to a permission area in which traveling by the automated driving without the driver's obligation to monitor the surroundings is permitted;
perform a switching advance notification that indicates to the driver that the switching schedule of the execution patterns has been grasped during traveling by the automated driving the driver's obligation to monitor the surroundings; and
control that an output mode of an area advance notification is different from an output mode of the switching advance notification when the vehicle is traveling in the non-permission area in a traffic congestion state, the area advance notification indicating to the driver that the movement schedule to the permission area is recognized.

22. A presentation control device configured to control presentation of information related to automated driving without driver's obligation to monitor surroundings, comprising:
an area grasping unit configured to grasp a movement schedule from a non-permission area in which traveling by the automated driving without the driver's obligation to monitor the surroundings is not permitted to a permission area in which traveling by the automated driving without the driver's obligation to monitor the surroundings is permitted; and
a notification control unit configured to perform a non-permission area notification when the movement schedule to the permitted area is grasped while traveling in the non-permitted area and the surroundings of the vehicle are in a traffic congestion state, the non-permission area notification indicating that the vehicle is in the traffic congestion state and indicating that traveling by the automated driving without the driver's obligation to monitor the surroundings is not permitted.

23. The presentation control device according to claim 22, wherein
the notification control unit is configured to omit the non-permission area notification when the surroundings of the vehicle are not in the traffic congestion state.

24. A non-transitory computer readable medium storing a computer program comprising instructions configured to be executed by a processor, the computer program being for control of presentation of information related to automated driving without driver's obligation to monitor surroundings, the instructions, when executed by the processor, causing the processor to:
grasp a movement schedule from a non-permission area in which traveling by the automated driving without the driver's obligation to monitor the surroundings is not permitted to a permission area in which traveling by the automated driving without the driver's obligation to monitor the surroundings is permitted; and
perform a non-permission area notification when the movement schedule to the permitted area is grasped while traveling in the non-permitted area and the surroundings of the vehicle are in a traffic congestion state, the non-permission area notification indicating that the vehicle is in the traffic congestion state and indicating that traveling by the automated driving without the driver's obligation to monitor the surroundings is not permitted.
